(19) United States
(12) Patent Application Publication
(10) Pub. No.: US 2026/0212420 A1
(43) Pub. Date: Jul. 23, 2026

(54) COLLATERALIZATION OF MEDICAL CLAIMS

(71) Applicant: Reclaimz Inc., Alpharetta, GA (US)

(72) Inventors: Anand Krishnan, Princeton, NJ (US); Seshadri Madapoosi, Alpharetta, GA (US)

(21) Appl. No.: 19/026,819

(22) Filed: Jan. 17, 2025

(51) Int. Cl. G06Q 40/08

(52) U.S. Cl. CPC G06Q 40/08

(57) ABSTRACT

The present disclosure relates to a system and a method for collateralization of medical claims. The method includes receiving a request to collateralize a medical claim from a medical facility, retrieving a set of input parameters for the medical claim, retrieving a historical claim data corresponding to a plurality of claim settlements from a database, determining a set of output parameters for the medical claim through a first Machine Learning (ML) model using the set of input parameters and the historical claim data, generating a first request for the preferred primary client using the set of input parameters and the set of output parameters, generating, in response to a reception of an acknowledgement to the first request, a dashboard entry for the medical claim using the set of input parameters and the set of output parameters, and adding the dashboard entry to the database.

### TECHNICAL FIELD

The embodiments of the present disclosure generally relate to the field of healthcare system management. More particularly, the present disclosure relates to collateralization of medical claims for resource exchange.

### BACKGROUND OF THE INVENTION

The subject matter disclosed in the background section should not be assumed or construed to be prior art merely due to its mention in the background section. Similarly, any problem statement mentioned in the background section or its association with the subject matter of the background section should not be assumed or construed to have been previously recognized in the prior art.

In recent years, healthcare sector has been under tremendous financial pressure due to the increase of costs accompanied by the unpredictable cash flow. Majority of the revenue of a healthcare facility comes from reimbursement of medical claims submitted by the payers for the services they have been rendered. However, processing of these medical claims can be challenging and may take several months, causing a financial crunch for the medical facility due to which they struggle in managing their finances.

To tackle this issue, majority of the healthcare facilities (such as hospitals) rely on raising capital from financial providers (such as banks) which provide loans at high interest rates. Moreover, the loan interest rate varies for each healthcare facility based on their credit ratings dependent on various factors corresponding to their line of credit such as worth of assets, revenue generated, services offered, and the cash in hand. Another way to raise capital is through Muni Bonds or issue debt, which again depends on hospitals credit rating, market they operate in, and their balance sheet.

Contemporary approaches used by the healthcare systems to raise capital are also very cumbersome and expensive, due to high interest rates, high number of agreements, and plethora of rules and regulations, which adds to the challenges of the healthcare systems. In view of the above-mentioned challenges, there is a requirement of a technical solution to address the broader problem.

### SUMMARY

The following embodiments present a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

According to an embodiment, a method for collateralizing medical claims is presented. The method includes receiving, from a medical facility, a request to collateralize a medical claim corresponding to at least one medical service rendered by the medical facility. The request to collateralize the medical claim comprises details of the medical claim and details of at least one preferred primary client to collateralize the medical claim. The method further includes retrieving, from the request to collateralize the medical claim, a set of input parameters for the medical claim. The set of input parameters includes a claim identifier, a claim amount, a claim date, and details of the at least one preferred primary client, for the medical claim. Furthermore, the method includes retrieving, from a database, a historical claim data corresponding to a plurality of claim settlements. Furthermore, the method includes determining, through a first Machine Learning (ML) model using the set of input parameters and the historical claim data, a set of output parameters for the medical claim. The set of output parameters includes a risk score for the medical claim, an expected claim settlement date, and a collateral value for the medical claim. The risk score and the collateral value for each medical claim dynamically change based on a variation in a claim age value of the medical claim, a days to pay (DTP) value for the medical claim, and/or a new claim settlement entry in the historical claim data for training the first ML model, or a combination of the aforementioned. Furthermore, the method includes generating a first request for the at least one preferred primary client using the set of input parameters and the set of output parameters. Furthermore, the method includes determining, whether a first acknowledgement is received from the at least one preferred primary client in response to the first request. Furthermore, in response to the reception of the first acknowledgement, the method includes generating a dashboard entry for the medical claim using the set of input parameters and the set of output parameters. Moreover, the method includes adding the dashboard entry to the database.

In some aspects of the present disclosure, prior to the addition of the dashboard entry in the database, the method further includes associating a medical facility identifier and at least one preferred primary client identifier with the dashboard entry.

In some aspects of the present disclosure, the claim age value corresponds to a duration between a present temporal value and the claim date. The days to pay value corresponds to a duration between the present temporal value and the expected claim settlement date.

In some aspects of the present disclosure, the method further includes determining, for the medical claim, a risk category from a plurality of risk categories based on the risk score associated with the medical claim. Furthermore, the method includes updating the set of output parameters by associating the determined risk category to the medical claim.

In some aspects of the present disclosure, the method further includes receiving a second request from the medical facility, where the second request includes a net collateral value, details of a secondary client, and a concentration limit corresponding to a maximum percentage of the net collateral value associated with each of the at least one primary client. Furthermore, the method includes determining, through a second ML model, a first set of medical claims from the plurality of medical claims based on the second request. Furthermore, the method includes retrieving, from the database, a first set of dashboard entries corresponding to the first set of medical claims. Furthermore, the method includes determining, through the second ML model, a first monitory value corresponding to the first set of medical claims, using the first set of dashboard entries. Furthermore, the method includes generating a third request for the secondary client using the first set of dashboard entries and the first monitory value. Furthermore, the method includes determining, whether a third acknowledgement is received from the secondary client in response to the third request. Furthermore, the method includes generating a resource exchange entry in response to the reception of the third acknowledgement and storing the resource exchange entry into the database.

In some aspects of the present disclosure, prior to the storage of the resource exchange entry in the database, the method further includes associating the medical facility identifier and a secondary client identifier with the resource exchange entry.

In some aspects of the present disclosure, the method further includes receiving a dashboard request from a user device associated with at least one of, the medical facility, the secondary client, or the at least one preferred primary client. The dashboard request comprises user defined input corresponding to at least of the medical facility identifier, the secondary client identifier, or the at least one preferred primary client identifier. Furthermore, the method includes determining, using a third ML model, one or more entries stored in the database based on the dashboard request and rendering the entries on the user device. The one or more entries includes at least one of, one or more dashboard entries, one or more resource exchange entries, or a combination thereof, corresponding to the user defined input.

In some aspects of the present disclosure, the new claim settlement entry in the historical claim data corresponds to a change in at least one of, a ranking of each of the at least one primary client, a rating of each of the at least one primary client, and a status of each of the at least one primary client.

According to another embodiment, a system to collateralize medical claims is presented. The system includes a database and a data processing circuitry communicatively coupled to the database. The data processing circuitry is configured to receive, from a medical facility, a request to collateralize a medical claim corresponding to at least one medical service rendered by the medical facility. The request to collateralize the medical claim comprises details of the medical claim and details of at least one preferred primary client to collateralize the medical claim. The data processing circuitry is further configured to retrieve, from the request to collateralize the medical claim, a set of input parameters for the medical claim. The set of input parameters comprises a claim identifier, a claim amount, a claim date, and details of the at least one preferred primary client, for the medical claim. Furthermore, the data processing circuitry is configured to retrieve, from the database, a historical claim data corresponding to a plurality of claim settlements. Furthermore, the data processing circuitry is configured to determine, through a first Machine Learning (ML) model using the set of input parameters and the historical claim data, a set of output parameters for the medical claim. The set of output parameters comprises a risk score for the medical claim, an expected claim settlement date, and a collateral value for the medical claim. The risk score and the collateral value for each medical claim dynamically change based on at least one of a variation in a claim age value of the medical claim, a days to pay (DTP) value for the medical claim, and a new claim settlement entry in the historical claim data for training the first ML model. Furthermore, the data processing circuitry is configured to generate a first request for the at least one preferred primary client using the set of input parameters and the set of output parameters. Furthermore, the data processing circuitry is configured to determine, whether a first acknowledgement is received from the at least one preferred primary client in response to the first request. Furthermore, the data processing circuitry is configured to generate, in response to the reception of the first acknowledgement, a dashboard entry for the medical claim using the set of input parameters and the set of output parameters. Moreover, the data processing circuitry is configured to add the dashboard entry to the database.

According to yet another embodiment, a computer-program product for collateralizing a plurality of medical claims is presented. The computer program product comprises computer-executable instructions that are stored on a non-transitory computer-readable medium and that, when executed by a data processing circuitry performs operations. The operations include receiving, from a medical facility, a request to collateralize a medical claim corresponding to at least one medical service rendered by the medical facility. The request to collateralize the medical claim comprises details of the medical claim and details of at least one preferred primary client to collateralize the medical claim. The operations further include retrieving, from the request to collateralize the medical claim, a set of input parameters for the medical claim. The set of input parameters includes a claim identifier, a claim amount, a claim date, and details of the at least one preferred primary client, for the medical claim. The risk score and the collateral value for each medical claim dynamically change based on at least one of a variation in a claim age value of the medical claim, a days to pay (DTP) value for the medical claim, and a new claim settlement entry in the historical claim data for training the first ML model. Furthermore, the operations include retrieving, from a database, a historical claim data corresponding to a plurality of claim settlements. Furthermore, the operations include determining, through a first Machine Learning (ML) model using the set of input parameters and the historical claim data, a set of output parameters for the medical claim. The set of output parameters includes a risk score for the medical claim, an expected claim settlement date, and a collateral value for the medical claim. Furthermore, the operations include generating a first request for the at least one preferred primary client using the set of input parameters and the set of output parameters. Furthermore, the operations include determining, whether a first acknowledgement is received from the at least one preferred primary client in response to the first request. Furthermore, in response to the reception of the first acknowledgement, the operations include generating a dashboard entry for the medical claim using the set of input parameters and the set of output parameters. Furthermore, the operations include adding the dashboard entry to the database.

### BRIEF DESCRIPTION OF DRAWINGS

Various embodiments disclosed herein will become better understood from the following detailed description when read with the accompanying drawings. The accompanying drawings constitute a part of the present disclosure and illustrate certain non-limiting embodiments of inventive concepts. Further, components and elements shown in the drawings are not necessarily to scale, emphasis instead being placed upon clearly illustrating the principles of the present disclosure. For the purpose of consistency and ease of understanding, similar components and elements are annotated by reference numerals in the exemplary drawings. In the drawings:

FIG. 1 presents a block diagram of a system to collateralize medical claims, in accordance with an exemplary aspect of the present disclosure;

FIG. 2 illustrates a block diagram depicting a data processing server, in accordance with an exemplary embodiment of the present disclosure;

FIG. 3 presents a block diagram depicting a Machine Learning (ML) model used to collateralize the medical claims, in accordance with an exemplary embodiment of the present disclosure;

FIG. 4 presents a block diagram of a user device, in accordance with an embodiment of the present disclosure;

FIG. 5(A)-5(C) illustrate Graphical User interfaces (GUIs) presented through the user device corresponding to generation of claim portfolio corresponding to selected medical claims, in accordance with an exemplary aspect of the present disclosure;

FIG. 6(A)-6(E) illustrate GUIs presented through the user device corresponding to resource exchange, in accordance with an exemplary aspect of the present disclosure;

FIG. 7 illustrates a GUI presented through the user device corresponding to management of the resource exchange, in accordance with an exemplary aspect of the present disclosure;

FIG. 8(A)-8(I) illustrate GUIs presented through the user device corresponding to onboarding and managing accounts of different entities of the system, in accordance with an exemplary aspect of the present disclosure;

FIG. 9 is a flow chart that depicts a process for generating and storing a dashboard entry corresponding to a collateralized medical claim, in accordance with an exemplary aspect of the present disclosure;

FIG. 10 is a flow chart that depicts a process for exchanging resources, in accordance with an exemplary aspect of the present disclosure; and

FIG. 11 is a flow chart that depicts a process for rendering information to a user of the user device, in accordance with an exemplary aspect of the present disclosure.

### DETAILED DESCRIPTION OF THE INVENTION

Inventive concepts of the present disclosure will now be described more fully hereinafter with reference to the accompanying drawings, in which examples of one or more embodiments of inventive concepts are shown. Inventive concepts may, however, be embodied in different forms and should not be construed as limited to the embodiments set forth herein. Further, the one or more embodiments disclosed herein are provided to describe the inventive concept thoroughly and completely, and to fully convey the scope of each of the present inventive concepts to those skilled in the art. Furthermore, it should be noted that the embodiments disclosed herein are not mutually exclusive concepts. Accordingly, one or more components from one embodiment may be tacitly assumed to be present or used in any other embodiment.

The following description presents various embodiments of the present disclosure. The embodiments disclosed herein are presented as teaching examples and are not to be construed as limiting the scope of the present disclosure. The present disclosure should in no way be limited to the illustrative implementations, drawings, and techniques illustrated below, including the exemplary design and implementation illustrated and described herein, but may be modified, omitted, or expanded upon without departing from the scope of the present disclosure.

The following description contains specific information pertaining to embodiments in the present disclosure. The detailed description uses the phrases “in some embodiments” which may each refer to one or more or all of the same or different embodiments. The term “some” as used herein is defined as “one, or more than one, or all.” Accordingly, the terms “one,” “more than one,” “more than one, but not all” or “all” would all fall under the definition of “some.” In view of the same, the terms, for example, “in an embodiment” refers to one embodiment and the term, for example, “in one or more embodiments” refers to “at least one embodiment, or more than one embodiment, or all embodiments.”

The term “comprising,” when utilized, means “including, but not necessarily limited to;” it specifically indicates open-ended inclusion in the so-described one or more listed features, elements in a combination, unless otherwise stated with limiting language. Furthermore, to the extent that the terms “includes,” “has,” “have,” “contains,” and other similar words are used in either the detailed description, such terms are intended to be inclusive in a manner similar to the term “comprising.”

In the following description, for the purposes of explanation, various specific details are set forth to provide a thorough understanding of embodiments of the present disclosure. It will be apparent, however, that embodiments of the present disclosure may be practiced without these specific details. Several features described hereafter can each be used independently of one another or with any combination of other features.

The description provided herein discloses exemplary embodiments only and is not intended to limit the scope, applicability, or configuration of the present disclosure. Rather, the foregoing description of the exemplary embodiments will provide those skilled in the art with an enabling description for implementing any of the exemplary embodiments. Specific details are given in the following description to provide a thorough understanding of the embodiments. However, it may be understood by one of the ordinary skilled in the art that the embodiments disclosed herein may be practiced without these specific details.

The terminology used herein is for the purpose of describing particular embodiments only and is not intended to be limiting of the disclosure. As used herein the description, the singular forms “a”, “an”, and “the” include plural forms unless the context of the invention indicates otherwise.

The terminology and structure employed herein are for describing, teaching, and illuminating some embodiments and their specific features and elements and do not limit, restrict, or reduce the scope of the present disclosure. Accordingly, unless otherwise defined, all terms, and especially any technical and/or scientific terms, used herein may be taken to have the same meaning as commonly understood by one having ordinary skill in the art.

The present disclosure relates to a system and a method for collateralizing medical claims. In some aspects of the present disclosure, the method includes a number of processes that may be utilized to provide a technical solution to the existing healthcare problems related to unpredictable cash flow. Particularly, the method includes a process to generate a dashboard entry corresponding to a medical claim. The dashboard entry includes various information fields corresponding to the medical claim related to a monitory value (i.e., a dynamic collateral value) determined for the medical claim, status of risk associated with the medical claim, information of preferred primary client(s) for resource exchange in lieu of the medical claim as collateral, and the like. The status of risk as well as the monitory value of the medical claim is dependent on a time duration that has passed since the medical claim has been generated. For example, the monitory value of the medical claim decreases as the time passes, whereas the risk associated with the medical claim increases with time.

The method further includes a process for exchanging resources in lieu of the collateralized claims. Furthermore, the method includes a process for managing the resource exchange as the monitory amount of the collateralized claims is dynamic. Moreover, the method includes presenting dashboard(s) including information about collateralization of medical claims, resource exchange, as well as details of various entities involved in the system such as collaterals, risk associated with the collaterals, and the like.

Some embodiments of the present disclosure relate to use of Machine Learning (ML) models to determine a dynamic risk score and a dynamic collateral value associated with a medical claim for collateralization. The ML models are trained using historical claim settlement data as well as various details of a payer of the medical claim, based on which the ML models are trained to determine a dynamic risk score as well as a monitory value for the medical claim as collateral. The ML models are further utilized to determine an amount that can be requested as a loan from a financial partner, when the medical claim is submitted as collateral. Moreover, the ML models are trained to generate a dynamic dashboard for a user of the system based on a set of inputs received from the user.

Some embodiments of the present disclosure relate to providing risk profile(s) of the collaterals along with analysis & trends of data for secondary client(s), based on which the secondary client(s) can make a decision for collateralization of the medical claim(s). In some aspects of the present disclosure, the secondary client may further be enabled to track the collaterals through a life cycle of the medical claims and make informed decision.

Some other embodiments of the present disclosure relate to designing a set of protocols for the exchange of monitory resources (such as a loan from a bank) in lieu of the medical claims as collaterals. In simpler words, the set of protocols relate to generating and managing claims portfolio in terms of a monitory value as well as a risk associated with using these medical claims as collaterals. Some embodiments of the present disclosure support access to alternate capital raised through “asset backed lending program” for collateralized claims funding facility. Some other embodiments of the present disclosure relate to managing resource exchange for the collateralized claims.

The following description provides specific details of certain aspects of the disclosure illustrated in the drawings to provide a thorough understanding of those aspects. It should be recognized, however, that the present disclosure can be reflected in additional aspects and the disclosure may be practiced without some of the details in the following description.

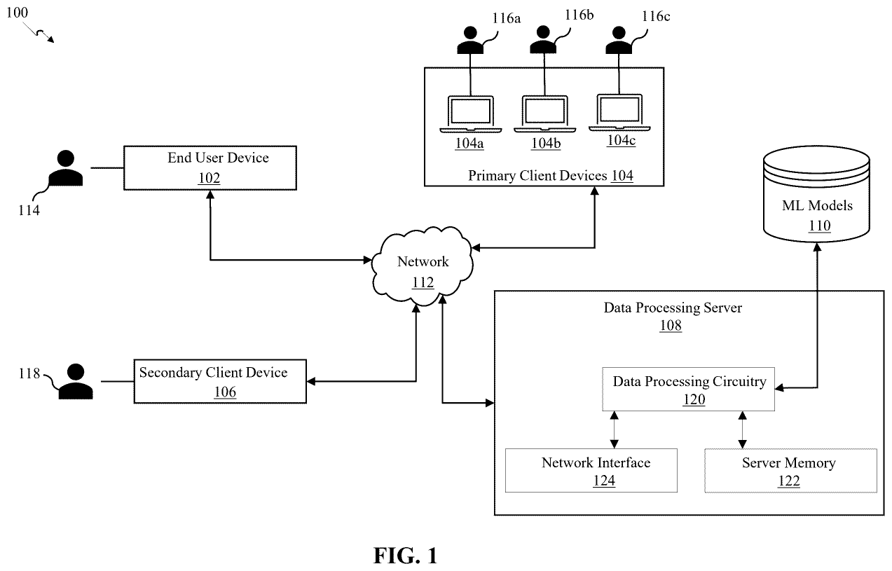

Embodiments of the present disclosure will be described below in detail with reference to the accompanying drawings. FIG. 1 through FIG. 11, discussed below, and the embodiments used to describe the principles of the present disclosure are by way of illustration only and should not be construed in any way to limit the scope of the present disclosure. Those skilled in the art will understand that the principles of the present disclosure may be implemented in any suitably arranged system or device.

Various aspects including the example aspects are now described more fully with reference to the accompanying drawings, in which the various aspects of the disclosure are shown. The disclosure may, however, be embodied in different forms and should not be construed as limited to the aspects set forth herein. Rather, these aspects are provided so that this disclosure is thorough and complete, and fully conveys the scope of the disclosure to those skilled in the art. In the drawings, the sizes of components may be exaggerated for clarity.

FIG. 1 presents a block diagram of a system 100 to collateralize medical claims, in accordance with an exemplary aspect of the present disclosure. The system 100 may include an end user device 102, primary client device(s) 104, a secondary client device 106, and a data processing server 108 supported by ML model(s) 110. Various entities of the system 100 may be communicatively coupled to each other by a network 112. The end user device 102 may be associated with the medical facility rendering medical services to patient(s) and may be operated by an end user 114 (e.g., hospital staff operating the end user device 102 on behalf of the medical facility). Each primary client device 104 may be operated by a primary client 116. For illustration, FIG. 1 presents first through third primary client devices 104a-104c operated by first through third clients 116a-116c, respectively. Specifically, the primary clients 116 may be financial payers, that are registered with the system 100 and may be capable of providing their resources (monetarily) in exchange of medical claim(s) as collateral. The secondary client device 106 may be operated by the secondary client 118. Specifically, the secondary client 118 may be a financial partner (such as a bank) registered with the system 100 that may provide monitory resources (i.e., by way of a loan) to the medical facility in exchange of the collateralized medical claim(s).

In some aspects of the present disclosure, the end user device 102 may enable the end user 114 to provide input(s) for collateralization of medical claim(s) rendered by the medical facility. The end user device 102 may enable the end user 114 to provide multiple selection inputs corresponding to a request to collateralize the medical claim(s). Specifically, the selection inputs may correspond to a selection of the medical claim(s) to be collateralize, a selection of preferred primary client(s) 116, a request for exchange of collateralized medical claim with resources of the secondary client 118, and the like. In some other aspects of the present disclosure, the end user device 102 may further facilitate the end user 114 to view a claim portfolio for the collateralized medical claim. Specifically, the claim portfolio may be generated by the data processing server 108 based on transaction(s) between the end user 114 and the clients (cumulatively referring to the primary clients 116 and the secondary client 118).

In some aspects of the present disclosure, the primary client device 104 may enable a corresponding primary client 116 to receive request(s) from the end user device 102. The request(s) may correspond to collateralizing medical claim(s) for medical service(s) rendered by the medical facility. The primary client device 104 may further enable the primary client 116 to provide selection input(s) to accept or reject request(s) from the end user device 102. Furthermore, based on the selection input(s) by the primary client 116, the data processing server 108 may be configured to collateralize the medical claim(s) or discard the request to collateralize the medical claim(s). Moreover, when the medical claim(s) are collateralized, the data processing server 108 may generate dashboard entries corresponding to each medical claim. The primary client device 104 may further enable the primary client 116 to provide display selection input(s), based on which a dashboard may be rendered (e.g., displayed or presented) to the primary client 116 through the primary client device 104. The dashboard facilitates the primary client 116 to manage collateralized transactions with the medical facility.

The presented embodiment shows three primary client devices 104 (i.e., the first through third primary client devices 104a-104c, operated by the first through third primary clients 116a-116c, respectively), however the scope of the present disclosure is not limited to it. In other embodiments, the primary client devices 104 may have any number of primary client devices, without deviating from the scope of the present disclosure. All the primary client devices 104 may be structurally and functionally similar to the first through third primary client devices 104a-104c, as presented herein.

In some aspects of the present disclosure, the secondary client device 106 may enable the secondary client 118 to receive resource exchange request(s) from the end user device 102. The resource exchange request(s) may enable the secondary client 118 to be informed of the collateralized medical claim(s) extended by the end user 114 in exchange of monitory resources (e.g., a loan) from the secondary client 118. The secondary client device 106 may further enable the secondary client 118 to accept or reject the resource exchange request(s) from the end user device 102. Moreover, when the secondary client 118 accepts the resource exchange request(s), the data processing server 108 may generate resource exchange entries corresponding to the resource exchange between the medical facility and the secondary client 118. The secondary client device 106 may further facilitate the secondary client 118 to provide selection input(s) to select data fields corresponding to instances of the resource exchange(s) between the secondary client 118 and the medical facility. Based on the selection input(s), the secondary client device 106 may further render information of resource exchange to the secondary client 118.

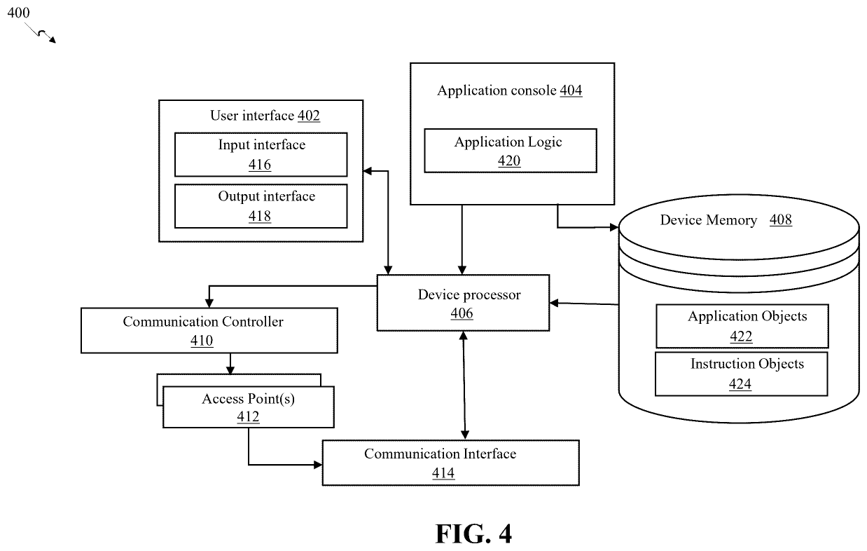

The end user device 102, the primary client device(s) 104, and the secondary client device 106 (presented later in FIG. 4 as ‘user device 400’ and cumulatively referred to as ‘user devices’) may be capable of communicating with the data processing server 108 through the network 112. Each of the user devices may have an electronic application installed, that enables them to interact with the data processing server 108. The electronic application may be hosted by the data processing server 108 such that an application interface of the electronic application may enable the users to provide input(s) and receive output(s) corresponding to collateralization of medical claim(s) and managing resource exchange between the medical facility and the clients (hereinafter referring cumulatively to the primary clients 116 and the secondary client 118). Examples of the user devices may include, but are not limited to portable handheld electronic devices such as a mobile phone, a tablet, a laptop, a smart watch etc., or fixed electronic devices such as a desktop computer, computing devices, etc. Aspects of the present disclosure are intended to include or otherwise cover any type of user device as the user device 400, without deviating from the scope of the present disclosure.

The data processing server 108 may be configured to perform data processing and/or data storage operations to collateralize the medical claim(s). More particularly, the data processing server 108 may be configured to create dashboard entries corresponding to acknowledged request(s) for collateralization of the medical claim(s). The data processing server 108 may further be configured to create resource exchange entries corresponding to acknowledged request(s) for resource exchange between the medical facility and the client(s) (cumulatively referring to the primary client 116 and the secondary client 118). Furthermore, the data processing server 108 may be configured to create dashboard entries for onboarding of client(s) to use the system 100. Furthermore, the data processing server 108 may be configured to manage the resource exchange(s) between the medical facility and the client(s). In some aspects of the present disclosure, based on the selection input(s), the data processing server 108 may be configured to generate dashboard(s) to be presented to the user (cumulatively referring to the end user 114, the primary client 116, and the secondary client 118).

The data processing server 108 may be a network of computers, a software framework, or a combination thereof, that may provide a generalized approach to create a server implementation. Examples of the data processing server 108 may include, but are not limited to, personal computers, laptops, mini-computers, mainframe computers, any non-transient and tangible machine that can execute a machine-readable code, cloud-based servers, distributed server networks, or a network of computer systems. The data processing server 108 may be realized through various web-based technologies such as, but not limited to, a Java web-framework, a .NET framework, a personal home page (PHP) framework, or any web-application framework. In various aspects of the present disclosure, the data processing server 108 may be configured to perform data processing and/or storage operations to enable collateralization of the medical claims.

The data processing server 108 may include data processing circuitry 120 and a server memory 122. The data processing circuitry 120 may include processor(s) configured with suitable logic, instructions, circuitry, interfaces, and/or codes for executing operations of various operations performed by the data processing server 108 for computations and data processing related to collateralization of the medical claims. Examples of the data processing circuitry 120 may include, but are not limited to, an Application Specific Integrated Chip (ASIC) processor, a RISC processor, a CISC processor, a Field Programmable Gate Array (FPGA), and the like.

The server memory 122 may be configured to store the logic, instructions, circuitry, interfaces, and/or codes of the data processing circuitry 120 for executing various operations of the system 100. Aspects of the present disclosure are intended to include and/or otherwise cover any type of the data associated with the data processing server 108, without deviating from the scope of the present disclosure. Examples of the server memory 122 may include but are not limited to, a ROM, a RAM, a flash memory, a removable storage drive, a HDD, a solid-state memory, a magnetic storage drive, a PROM, an EPROM, and/or an EEPROM.

Moreover, the data processing server 108 may also include a network interface 124. The network interface 124 may be configured to enable the data processing server 108 to communicate with various other entities of the system 100 via the network 112. Examples of the network interface 124 may include, but are not limited to, a MODEM, a network interface such as an Ethernet card, a communication port, and/or a Personal Computer Memory Card International Association (PCMCIA) slot and card, an antenna, a radio frequency (RF) transceiver, amplifier(s), a tuner, oscillator(s), a digital signal processor, a coder-decoder (CODEC) chipset, a Subscriber Identity Module (SIM) card, and a local buffer circuit. It will be apparent to a person of ordinary skill in the art that the network interface 124 may include any device and/or apparatus capable of providing wireless or wired communications between the data processing apparatus 108 and various other entities of the system 100.

The data processing server 108 may be supported by ML models 110 to perform data processing task(s) associated with the operations of the system 100. The ML models 110 may be trained to determine a dynamic risk value and an associated dynamic collateral value for a medical claim (i.e., a monitory equivalent value for the medical claim collateralized as asset). The ML models 110 may further be configured to determine medical claim(s) from a number of medical claims associated with the medical facility to be collateralized for resource exchange with the clients based on selection inputs from the clients (such as a net collateral value, a collateral exchange value, and the like). Furthermore, the ML models 110 may be trained to generate dashboard entries for the clients reflecting resource exchange transaction(s) between the clients based on a user selection. In some aspects of the present disclosure, the ML models 110 may be hosted by external datacenter(s). The external datacenter(s) may include suitable logic, circuitry, and/or code(s) to store data and perform computational tasks to support the data processing server 108. Examples of the external data center(s) may include, but are not limited to Oracle Database, Amazon Web Services (AWS) Database, and the like.

The network 112 may include suitable logic, circuitry, and interfaces that may be configured to provide several network ports and several communication channels for transmission and reception of data related to operations of various entities of the system 100. Each network port may correspond to a virtual address (or a physical machine address) for transmission and reception of the communication data. For example, the virtual address may be an Internet Protocol Version 4 (IPV4 ) (or an IPV6 address) and the physical address may be a Media Access Control (MAC) address. The network 112 may be associated with an application layer for implementation of communication protocols based on communication requests from the various entities of the system 100. The communication data may be transmitted or received via the communication protocols. Examples of the communication protocols may include, but are not limited to, Hypertext Transfer Protocol (HTTP), File Transfer Protocol (FTP), Simple Mail Transfer Protocol (SMTP), Domain Network System (DNS) protocol, Common Management Interface Protocol (CMIP), Transmission Control Protocol and Internet Protocol (TCP/IP), User Datagram Protocol (UDP), Long Term Evolution (LTE) communication protocols, or any combination thereof. In some aspects of the present disclosure, the communication data may be transmitted or received via at least one communication channel of several communication channels in the network 112. The communication channels may include, but are not limited to, a wireless channel, a wired channel, a combination of wireless and wired channel thereof. The wireless or wired channel may be associated with a data standard which may be defined by one of a Local Area Network (LAN), a Personal Area Network (PAN), a Wireless Local Area Network (WLAN), a Wireless Sensor Network (WSN), Wireless Area Network (WAN), Wireless Wide Area Network (WWAN), a metropolitan area network (MAN), a satellite network, the Internet, an optical fiber network, a coaxial cable network, an infrared (IR) network, a radio frequency (RF) network, and a combination thereof. Aspects of the present disclosure are intended to include or otherwise cover any type of communication channel, including known, related art, and/or later developed technologies.

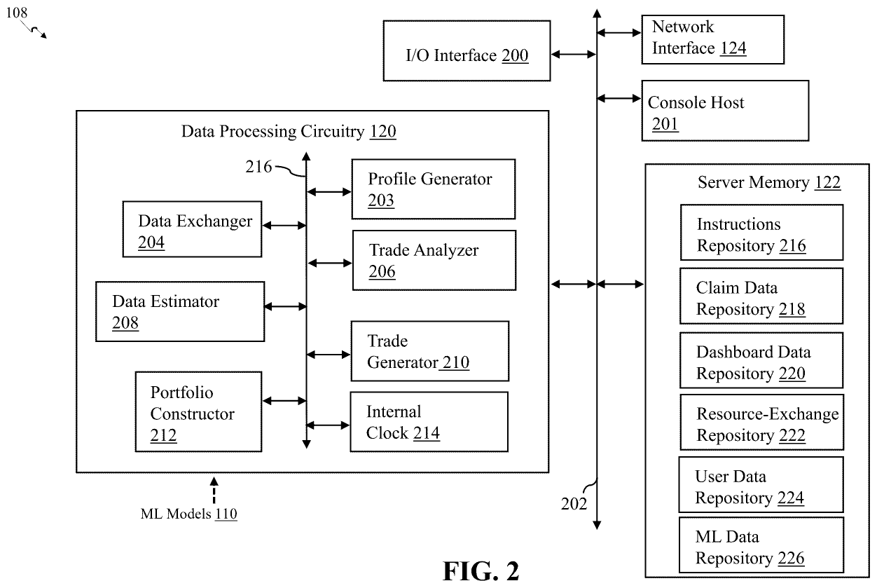

FIG. 2 illustrates a block diagram depicting the data processing server 108, in accordance with an exemplary embodiment of the present disclosure. The data processing server 108 may be configured to perform data processing task(s) and data storage task(s) for collateralization of the medical claims. According to the exemplary embodiment as presented through FIG. 2, the data processing server 108 may include the data processing circuitry 120, the server memory 122, the network interface 124, an input-output (I/O) interface 200, and a console host 201 coupled to each other by way of a first communication bus 202.

The I/O interface 200 may include suitable logic, circuitry, interfaces, and/or codes that may be configured to receive input(s) and render output(s) by or from the data processing server 108, respectively. The input(s) may correspond to operation(s) and configuration(s) of various components of the data processing server 108. The output(s) may correspond to an operational status of various components of the data processing server 108.

The console host 201 may include suitable logic, circuitry, interfaces, and/or codes that may be configured for executing various operations of the electronic application on the user devices, by way of which a user can trigger the data processing server 108 to collateralize the medical claims. In some other aspects of the present disclosure, the console host 201 may further provide Graphical User Interfaces (GUIs) for the data processing server 108 for user interaction.

In the exemplary embodiment as presented through FIG. 2, the data processing circuitry 120 may include a profile generator 203, a data exchanger 204, a trade analyzer 206, a data estimator 208, a trade generator 210, a portfolio constructor 212, and an internal clock 214. Various components of the data processing circuitry 120 may be communicatively coupled to each other by way of a second communication bus 216.

The profile generator 203 may be configured to receive user registration data from the user devices (cumulatively referring to the end user device 102, the primary client devices 104, and the secondary client device 106). The user registration data may include personal identifier containing identity information of the user of the user device. In some aspects of the present disclosure, the user registration data may also include biometric data of the user such as, but not limited to, fingerprints, iris scans, images, voice samples, and the like associated with the user. Aspects of the present disclosure are intended to include or otherwise cover any type of biometric data of the plurality of users without deviating from the spirit and scope of the present disclosure.

The profile generator 203 may further be configured to authenticate the user registration data. In some aspects of the present disclosure, the profile generator 203 may be configured to fetch an identity data of the user from external sources. Furthermore, the profile generator 203 may fetch identity information from the identity data and may compare the identity information fetched from the user registration data with the identity information derived from the identity data. In a scenario, when both the information data match with each other, the profile generator 203 may authenticate the identity of the user and may proceed to generate a user profile for the user based on the identity information derived from the user registration data. In some aspects of the present disclosure, the profile generator 203 may enable the user to set the password protection for logging-in to the system 100. In such a scenario, the profile generator 203 may be configured to verify a password entered by the user for logging-in to the system 100 by comparing the password entered by the user with the set password protection. In a scenario, when the password entered by the user is verified, the profile generator 203 may enable the user to log-in to the system 100. In a scenario, when the password entered by the user is not verified, the profile generator 203 may generate a login error signal to enable a login error to be displayed on the user device.

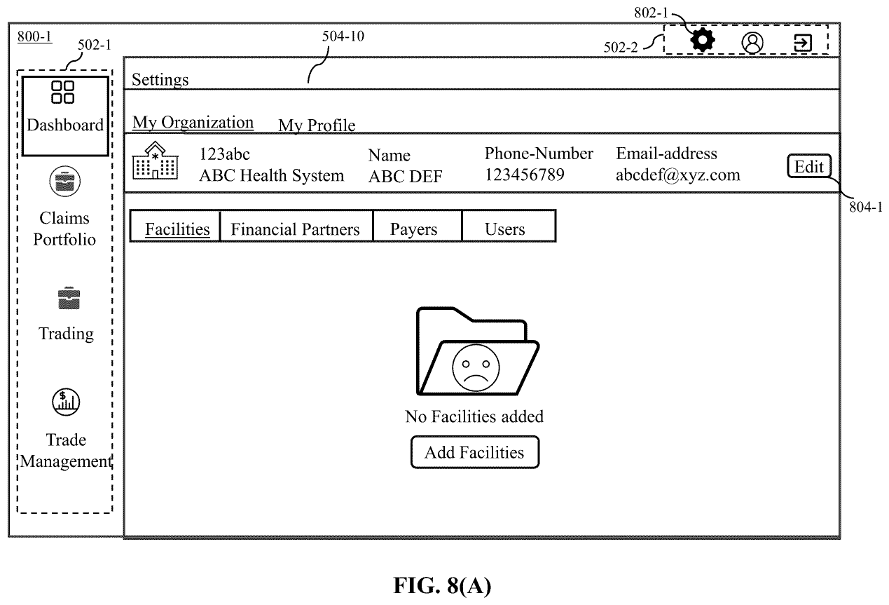

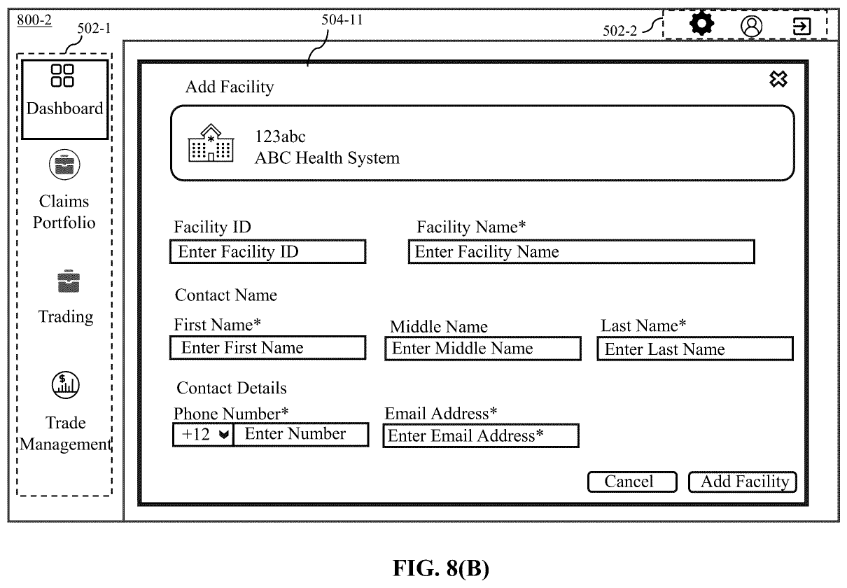

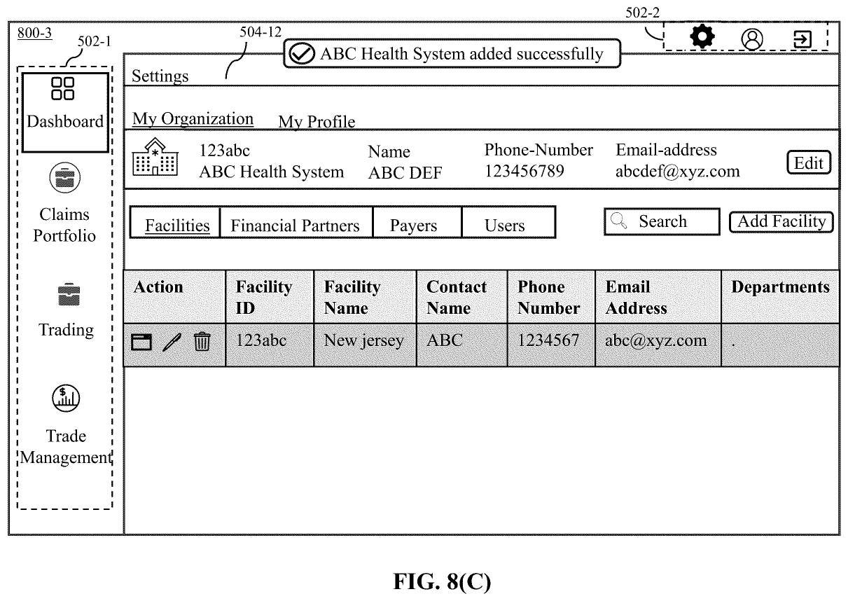

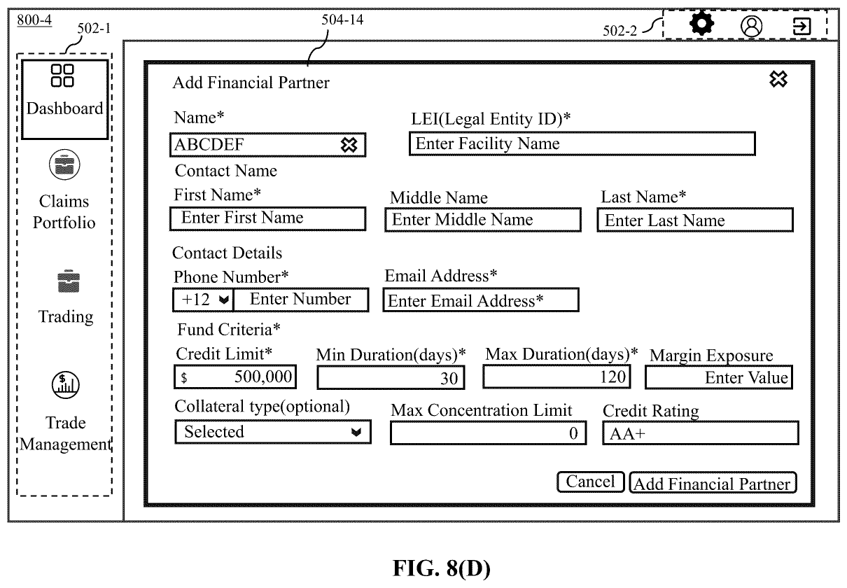

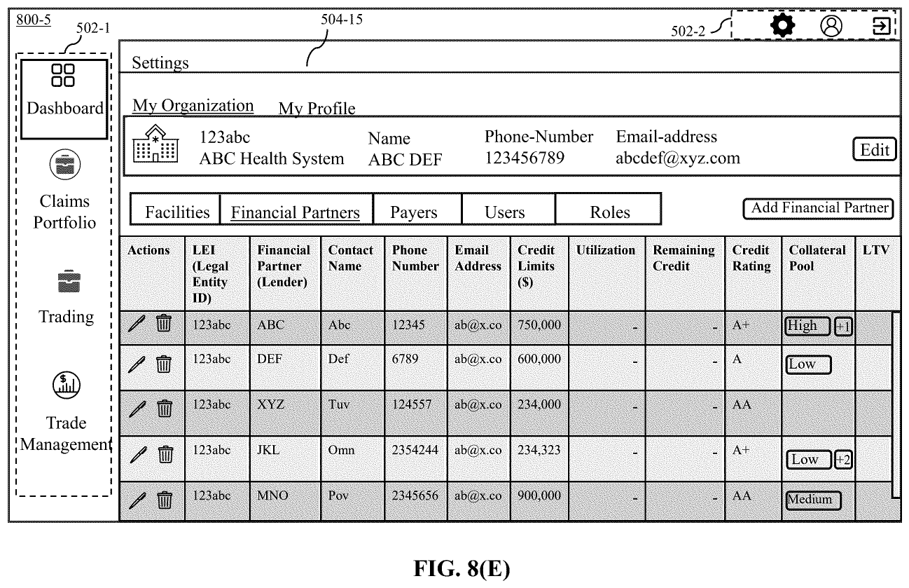

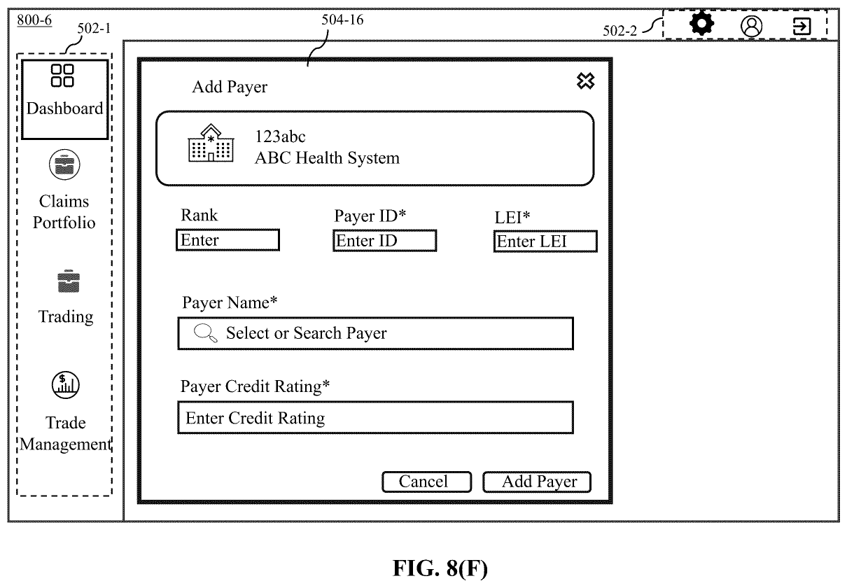

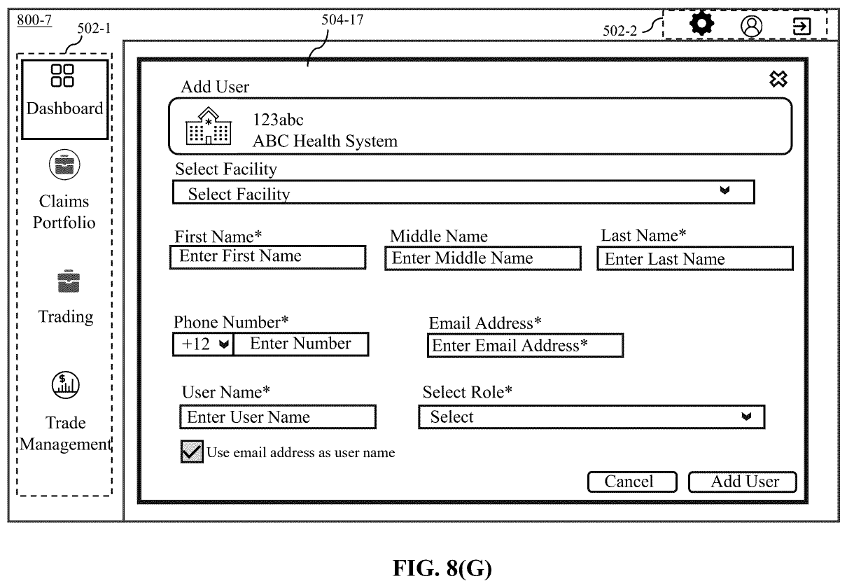

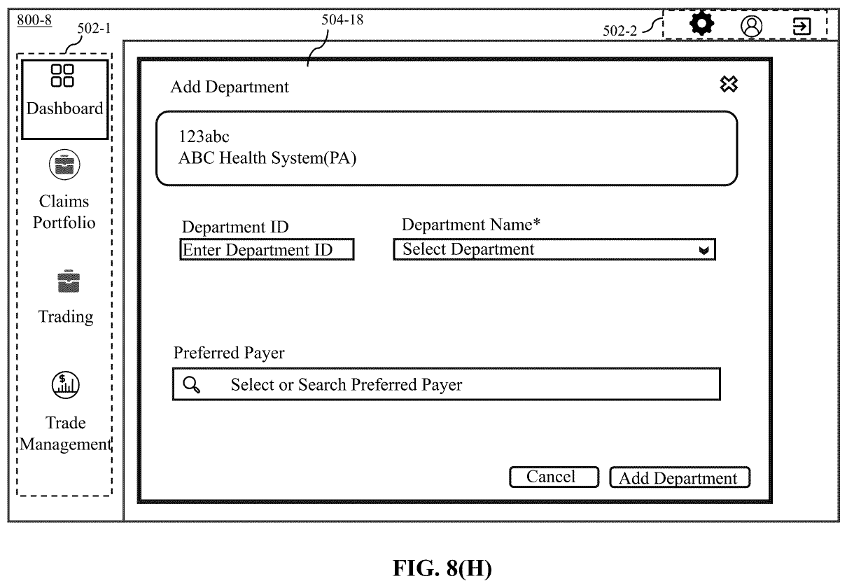

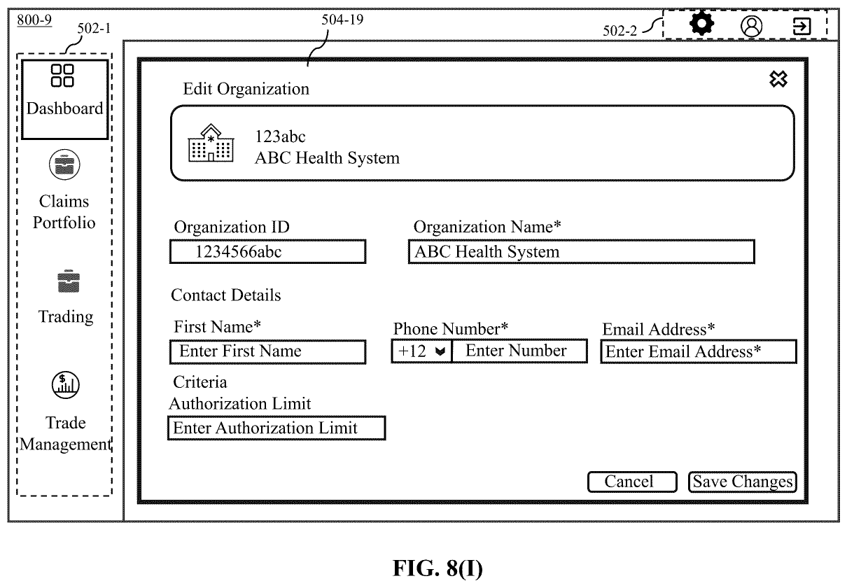

In some other aspects of the present disclosure, the profile generator 203 may further be configured to generate dashboard elements (e.g., data input elements and/or data display elements) to facilitate the user to provide input(s) and receive output(s) related to user details. For example, the profile generator 203 may generate dashboard elements to add, edit, and/or display details corresponding to the medical facility (i.e., corresponding to the end user device 102), the primary client 116, and the secondary client 118 (presented later from FIG. 8(A) through FIG. 8(I).

The data exchanger 204 may be configured to enable exchange of data and/or instruction(s) between the server memory 122, the primary client devices 104, the secondary client device 106, the end user device 102, and various other entities of the data processing circuitry 120. Particularly, the data exchanger 204 may be configured to receive request(s) to collateralize the medical claim corresponding to medical service(s) rendered by the medical facility, from the end user device 102. The request to collateralize the medical claim may include details of the medical claim and details of preferred primary client(s) 116 to collateralize the medical claim. The data exchanger 204 may further be configured to retrieve a historical claim data corresponding to past claim settlements, from the server memory 122. In some aspects of the present disclosure, the historical claim data may be stored in an external database (not shown). In such a scenario, the data exchanger 204 may be configured to generate a data fetch signal for the external database to retrieve the historical claim data from the external database. In some aspects of the present disclosure, the request to collateralize the medical claim(s) may correspond to resource exchange between the medical facility and the primary clients 116. Specifically, the request may be associated with generation of a trade between the medical facility and the primary client(s) 116, which enables collateralized medical claims belonging to the medical facility to be exchanged for monitory resources of the primary client(s) 116 (that may be referred to as payers of the collateralized claims).

The data exchanger 204 may further be configured to receive a second request from the end user device 102. The second request may include a net collateral value, details of the secondary client 118, and a preferred risk category for the medical claim(s) to be exchanged for resources. In some aspects of the present disclosure, the second request may correspond to resource exchange between the medical facility and the secondary client 118. Specifically, the second request may be associated with generation of a trade between the medical facility and the secondary client 118, which enables collateralized medical claims belonging to the medical facility to be exchanged for monitory resources of the secondary client 118 (to provide a loan to the medical facility in exchange of the collateralized medical claims).

Furthermore, the data exchanger 204 may be configured to exchange data and/or instructions with the ML models 110 which may provide Artificial intelligence (AI) support for collateralization of the medical claim(s).

The data estimator 208 may be configured to retrieve, from the request to collateralize the medical claim, a set of input parameters for the medical claim. The set of input parameters for a medical claim may include, but are not limited to, a claim identifier, a claim amount, a claim date, details of the preferred primary client(s) 116, and a department listed on the medical claim. In some aspects of the present disclosure, the details of the preferred primary client(s) 116 may include data corresponding to a ranking of each of the preferred primary client(s) 116, a rating of each of the preferred primary client(s) 116, and a claim payment status of each of the preferred primary client(s) 116. Aspects of the present disclosure are intended to include or otherwise cover any type of healthcare parameters that may be directly observed from a medical claim as the set of input parameters, without deviating from the scope of the present disclosure.

The data estimator 208 may further be configured to determine, through a first Machine Learning (ML) model 110 from the ML models 110, a set of output parameters for the medical claim using the set of input parameters and the historical claim data. The set of output parameters for the medical claim may include, but are not limited to, a risk score for the medical claim, an expected claim settlement date, and a collateral value for the medical claim. Aspects of the present disclosure are intended to include or otherwise cover any type of output parameters in the set of output parameters for the medical claim, as may be determined by the first ML model 110 to collateralize the medical claim, without deviating from the scope of the present disclosure.

The data estimator 208 may further be configured to determine a set of derived output parameters for the medical claim. In some aspects of the present disclosure, the set of derived output parameters for the medical claims may include a claim age value and a days to pay (DTP) value for the medical claim. The claim age value corresponds to a duration between a present temporal value and the claim date, and the days to pay value corresponds to a duration between the present temporal value and the expected claim settlement date. The present temporal value may be determined by the internal clock 214, that is configured to keep track of time and calendar date. In some aspects of the present disclosure, the data estimator 208 may be configured to determine the DTP value using the first ML model 110. The data estimator 208 may further determine the expected claim settlement date based on the DTP value. In some aspects of the present disclosure, the data estimator 208 may be configured to determine an estimated date of payment for the medical claim using the first ML model 110, based on the set of input parameters of the medical claim. The data estimator 208 may further determine the DTP value based on a difference between the estimated date of payment value and the present temporal value (i.e., present calendar date). Particularly, the risk score and the collateral value for each medical claim dynamically change based on variation(s) in the claim age value of the medical claim, the days to pay (DTP) value for the medical claim, and/or a new claim settlement entry in the historical claim data for training the first ML model 110. Therefore, the dashboard entries may change periodically, continuously, dynamically, or based on a user's intervention, as may be determined through the first ML model 110.

In some aspects of the present disclosure, the risk score for the medical claim may dynamically change with time. Specifically, the data estimator 208, by use of the first ML model 110 may dynamically alter (i.e., increase) the risk score for the medical claim with increase in the claim age value and decrease in the DTP value. Moreover, the data estimator 208 may decrease the collateral value of the medical claim with an increase in the risk score.

Based on the risk score value, the data estimator 208 may further assign a risk status to the medical claim. For example, when the dynamic risk score value is between a range of 0 to 5, the data estimator 208 may assign ‘low risk’ status to the medical claim. When the dynamic risk score value is between a range of 6-10, the data estimator 208 may assign a ‘medium risk’ status to the medical claim. Moreover, when the dynamic risk score value’ is between a range of 11-15, the data estimator 208 may assign a ‘high risk’ status to the medical claim. Furthermore, when the dynamic risk score value is between a range of 16-20, the data estimator 208 may assign a ‘very high risk’ status with the medical claim. Based on the dynamic risk score and the changing days to pay value, the data estimator 208 may further be configured to update the collateral value for the medical claim.

In some aspects of the present disclosure, the risk status may be reflected on a dashboard to the user, which enables the user to make informed decision to collateralize the medical claim and/or exchange the collateralized medical claim for resources.

In some aspects of the present disclosure, the set of derived output parameters may further include a value of estimated days remaining till payment, a payer ranking for each primary client 116, a DTP group, a claim age group, a value of collateral claim ratio (CCR), and a CCR group. The data estimator 208 may determine the value of estimated days remaining till payment based on a difference between the estimated date of payment value and the present temporal value. Based on the DTP value, the data estimator 208 may be configured to assign the DTP group from a number of DTP groups to the medical claim.

In some aspects of the present disclosure, the data estimator 208 may determine the CCR value by dividing the collateral value of the medical claim with the claim value of the medical claim. As the risk associated with a medical claim is dependent on time, the CCR value also changes with time. Based on the CCR value of the medical claim, the data estimator 208 may be configured to assign a CCR group to the medical claim.

In an exemplary scenario, when the DTP value for the medical claim is between a range of 0-30 days, the data estimator 208 may assign the medical claim to ‘DTP group 1’. Similarly, when the DTP value for the medical claim is between a range of 31-45 days, the data estimator 208 may assign the medical claim to ‘DTP group 2’. Moreover, when the DTP value for the medical claim is between a range of 46-90 days, the data estimator 208 may assign the medical claim to ‘DTP group 3’. Furthermore, when the DTP value for the medical claim is between a range of 91-150 days, the data estimator 208 may assign the medical claim to ‘DTP group 4’. Furthermore, when the DTP value for the medical claim is above 151 days, the data estimator 208 may assign the medical claim to ‘DTP group 5’.

In another exemplary scenario, when the CCR value is between a range of 0-10, the data estimator 208 may assign the medical claim to ‘CCR group 1’. When the CCR value is between a range of 11-20, the data estimator 208 may assign the medical claim to ‘CCR group 2’. When the CCR value is between a range of 21-30, the data estimator 208 may assign the medical claim to ‘CCR group 3’. When the CCR value is between a range of 31-40, the data estimator 208 may assign the medical claim to ‘CCR group 4’. When the CCR value is between a range of 41-50, the data estimator 208 may assign the medical claim to ‘CCR group 5’. When the CCR value is between a range of 51-60, the data estimator 208 may assign the medical claim to ‘CCR group 6’. When the CCR value is between a range of 61-70, the data estimator 208 may assign the medical claim to ‘CCR group 7’. When the CCR value is between a range of 71-80, the data estimator 208 may assign the medical claim to ‘CCR group 8’. When the CCR value is between a range of 81-90, the data estimator 208 may assign the medical claim to ‘CCR group 9’. When the CCR value is between a range of 91-100, the data estimator 208 may assign the medical claim to ‘CCR group 10’.

The data estimator 208 may further be configured to assign a claim age group to the medical claim based on the claim age of the medical claim. In an exemplary scenario, when the claim age value of the medical claim is between a range of 0-30 days, the data estimator 208 may assign the medical claim to ‘claim group 1’. When the claim age value of the medical claim is between a range of 31-45 days, the data estimator 208 may assign the medical claim to ‘claim group 2’. When the claim age value of the medical claim is between a range of 46-90 days, the data estimator 208 may assign the medical claim to ‘claim group 3’. When the claim age value of the medical claim is between a range of 91-150 days, the data estimator 208 may assign the medical claim to ‘claim group 4’. When the claim age value of the medical claim is above 151 days, the data estimator 208 may assign the medical claim to ‘claim group 5’.

The data estimator 208 may further be configured to generate a first request for the preferred primary client(s) 116 using the set of input parameters and the set of output parameters of the medical claim. Furthermore, the data estimator 208 may determine, whether a first acknowledgement is received from any of the preferred primary client(s) 116 in response to the first request. The first acknowledgement may refer to an acceptance towards the first request (i.e., for collateralization of the medical claim and resource exchange between the medical facility associated with the medical claim and the preferred primary client 116). In an exemplary scenario, when the trade generator 210 determines a reception of the first acknowledgement from the primary client 116, the data estimator 208 may generate a dashboard entry for the medical claim and may store the dashboard entry in the server memory 122. In some aspects of the present disclosure, prior to the addition of the dashboard entry in the server memory 122, the data estimator 208 may associate a medical facility identifier and a preferred primary client identifier(s) with the dashboard entry corresponding to the collateralized medical claim.

The trade generator 210 may be configured to determine, through a second ML model 110 from the ML models 110, a first set of medical claims from a number of medical claims stored in the server memory 122 based on the second request. The second request may include a net collateral value, details of the secondary client 118, a concentration limit for each of the preferred primary client(s) 116. The concentration limit may correspond to a maximum percentage of the net collateral value associated with each of the preferred primary client(s) 116 that can be collateralized for resource exchange. In some aspects of the present disclosure, the second request may further include a preferred risk category (i.e., associated with the risk status), and a department of interest. The department of interest may refer to a department of treatment associated with the collateralized medical claim.

Specifically, the second request may be generated by the end user device 102 to exchange the collateralized medical claim for monitory resources (such as a loan) from the secondary client 118. Based on the contents of the second request, the trade generator 210 may retrieve a first set of dashboard entries corresponding to the first set of medical claims, from the server memory 122. In some aspects of the present disclosure, the first set of dashboard entries may include the set of input parameters and the set of output parameters, as well as the set of derived output parameters of medical claim(s) matching with the contents (or user requirements) of the second request.

The trade generator 210 may further be configured to determine, through a second ML model 110 from the ML models 110, a first monitory value corresponding to the first set of medical claims, using the first set of dashboard entries. In some aspects of the present disclosure, the trade generator 210, using the second ML model 110 may select dashboard entries from the ones stored in the server memory 122, that correspond to collateralized medical claims by the primary client(s) 116. Based on the selected dashboard entries, the trade generator 210 may generate data display elements, that can be displayed to the secondary client 118. In some aspects of the present disclosure, the data display items may be presented to the secondary client 118 in the form of a bucket of collateralized claims. Content(s) of the bucket may be customized based on selection(s) made by the secondary client 118. Moreover, the trade generator 210 may be configured to generate a third request for the secondary client using the first set of dashboard entries and the first monitory value. Furthermore, the trade generator 210 may determine whether a third acknowledgement is received from the secondary client in response to the third request. The third acknowledgement may refer to acceptance of the third request (i.e., for resource exchange between the medical facility and the secondary client 118). In an exemplary scenario, when the trade generator 210 determines acknowledgement of medical claim(s) for resource exchange from the secondary client 118, the trade generator 210 may generate a resource exchange entry and may store the resource exchange entry in the server memory 122. In some aspects of the present disclosure, prior to the storage of the resource exchange entry in the server memory 122, the medical facility identifier and a secondary client identifier with the resource exchange entry.

The trade analyzer 206 may be configured to analyze changes in various resource exchange entries with time. Specifically, the trade analyzer 206 may determine a difference between the net collateral value and the first monitory value for the first set of medical claims. At an instance of time, when the trade analyzer 206 determines that the difference between the net collateral value and the first monitory value is less than a margin exposure value, the trade analyzer 206 may generate a resource exchange upgrade trigger. Moreover, the trade analyzer 212 may be configured to identify a need to update the medical claim(s) for resource exchange. The trade analyzer 206, through the second ML model 110, may determine a second set of medical claims from the plurality of medical claims, in response to the resource exchange upgrade trigger, based on the updated monitory value. In response, the trade analyzer 206 may also retrieve a second set of dashboard entries corresponding to the second set of medical claims, from the server memory 122. Further, the trade analyzer 206 may determine, through the second ML model 110, a second monitory value corresponding to the second set of medical claims, using the second set of dashboard entries. Furthermore, the trade analyzer 206 may be configured to generate a fourth request for the secondary client 118 using the second set of dashboard entries and the second monitory value. The fourth request may correspond to exchange of the resources of the secondary client at the second monitory value. Furthermore, the trade analyzer 206 may determine whether a fourth acknowledgement is received from the secondary client 118 in response to the fourth request. In a scenario, when the fourth acknowledgement is received from the secondary client device 118, the trade analyzer 206 may generate an updated resource exchange entry and may store it into the server memory 122. In another scenario, when the fourth acknowledgement is not received from the secondary client device 118, the trade analyzer 206 may discard the fourth request.

The portfolio constructor 212 may be configured to generate a dashboard portfolio of medical claim(s) to be presented to a user of the user device (cumulatively referring to the end user device 102 associated with the medical facility, the primary client device 104, and the secondary client device 106). Particularly, the portfolio constructor may receive a dashboard request from the user device. The dashboard request may include user defined input corresponding to the medical facility identifier, the secondary client identifier, or the at least one preferred primary client identifier. The portfolio constructor 212 may further be configured to determine, using a third ML model 110 from the ML models 110, entries stored in the server memory 112 based on the dashboard request. The entries may include one or more dashboard entries, one or more resource exchange entries, or a combination of them, corresponding to the user defined input. Furthermore, the portfolio constructor 212 may generate a portfolio generation trigger that enables the entries to be rendered (displayed or presented) on the user device.

Various components of the data processing circuitry 120 are presented to illustrate the functionality driven by the data processing server 108. It will be apparent to a person having ordinary skill in the art that various components in the data processing circuitry 120 are for illustrative purposes and not limited to any specific combination of hardware circuitry and/or software.

The server memory 122 may be configured to store data corresponding to system 100. In some aspects of the present disclosure, server memory 122 may be segregated into multiple repositories that may be configured to store a specific type of data. In the exemplary embodiment as presented through FIG. 2, the server memory 122 may include an instructions repository 216, a claim data repository 218, a dashboard repository 220, a resource-exchange repository 222, a user data repository 224, and a ML data repository 226.

The instructions repository 216 may be configured to store instructions for various components of the data processing server 108. The claim data repository 218 may be configured to store data associated with the collateralized medical claims of the system 100. The dashboard data repository 220 may be configured to store data corresponding to dashboard request(s) from the users. Moreover, the dashboard data repository 220 may store dashboard element(s) generated by the data processing circuitry 120. The resource-exchange repository 222 may be configured to store data associated with resource exchange between the end user 114 and the clients (cumulatively referring to the primary client(s) 116 and the secondary client 118). The user data repository 224 may be configured to store data associated with registration and/or authentication of users of the system 100. The ML data repository 226 may be configured to retrieve data and/or instruction(s) from the ML models 110 that may be utilized by various components of the data processing circuitry 120 for collateralization of medical claim(s) or resource exchange in lieu of the collateralized medical claim(s).

Various components of the server memory 122 are presented for illustration as per the functionality of the data processing server 108. It will be apparent to a person having ordinary skill in the art that various components in the server memory 120 are for illustrative purposes and the scope of the present disclosure is not limited by the specific repositories as presented herein through FIG. 2. The server memory 122 may include any count and/or type of data storage repositories, without deviating from the scope of the present disclosure.

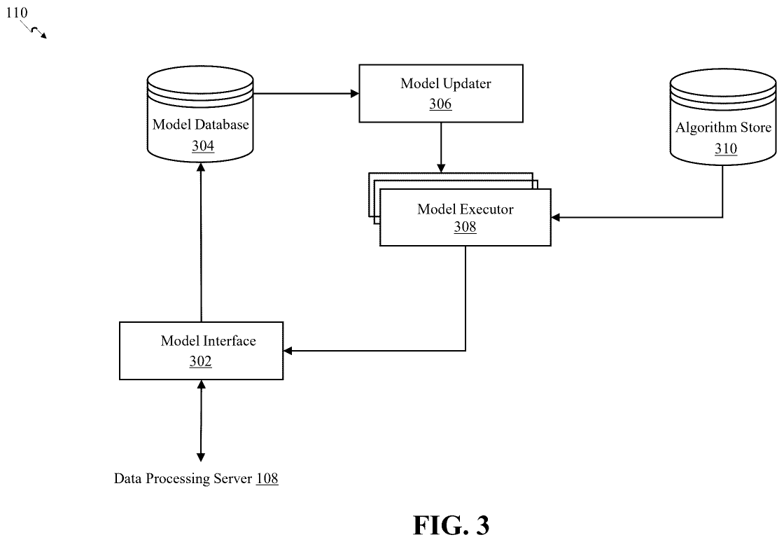

FIG. 3 is a block diagram that depicts a machine learning (ML) model 110 to collateralize the medical claims, according to an exemplary embodiment. The ML model 110 may include a model interface 302, a model database 304, a model updater 306, a model executor 308, and an algorithm store 310. In the exemplary embodiment, the first through third ML models 110 (as discussed in FIG. 2) may be designed in accordance with the ML model 110 as presented herein.

The model interface 302 may receive training data based on the functionality of various components of data processing circuitry 120. The model interface 302 may further send model-generated output(s) to the data processing server 108. Furthermore, the model interface 302 may receive feedback data from the data processing server 108 and may transmit the feedback data to model database 304. The model updater 306 may access the feedback data to update parameter(s) (such as weights, bias, number of layers, filters, pooling type etc.) of the model executor 308 for training specific collateralization of the medical claims or exchange in resources in lieu of the collateralized medical claims. Additionally, the model interface 302 may receive instruction data from the data processing server 108 and may transmit classified information to the data processing server 108.

The model database 304 may store neural networks, weights of neurons for the neural networks, input data for the neural networks, output data from the neural networks, and the like. Additionally, the model database 304 may transmit a neural network from the stored neural networks to the model updater 306. The model database 304 further sends the feedback data to model updater 306. Based on the feedback data, the model updater 306 may update the parameters of ML model for customized training specific to each functionality of the data processing server 108.

The model executor 308 may receive data from the model updater 306 that includes a customized training regimen specific to each object and the feedback data. Based on the data received from the model updater 306, the model executor 308 may retrieve ML algorithms from the algorithm store 310 to perform operation(s) for the data processing server 108. Particularly, the model executor 308 may include an input neurons layer configured to receive data from the model interface 302, hidden neuron layer(s) configured to propagate the received data for classification, and an output neuron layer configured to depict an output in accordance with the functionality of a component of the data processing server 108. Moreover, the model executor 308 is trained for specific task(s) to classify the input data to generate the output. Each neuron of the model executor 308 may be attached with a weight and a bias, that is determined via training of the ML model 110.

In some aspects of the present disclosure, the model executor 308 may be designed using field programmable gate array (FPGA) and/or application specific integrated chip (ASIC) programmed for a specific ML functionality to support the data processing server 108. In some aspects of the present disclosure, each of the first through third ML models 110 may be designed using Gradient-Boosting (GB) ML models. It will be apparent to a person of ordinary skill in the art that the scope of the ML models 110 is not limited only to use of the GB models. Rather, the scope of the present disclosure is limited to the functionality of the data processing server 108 as presented in FIG. 2, that may be supported by any utilize any ML model existing, or designed later in advancement of the technology, without deviating from the scope of the present disclosure.

In some aspects of the present disclosure, the model executor 308 may transmit indication of a ML algorithm to algorithm store 310. The algorithm store 310 may store multiple ML algorithms. Based on the indication, the algorithm store 310 may transmit the corresponding ML algorithm from the multiple machine learning algorithms to be used by the model executor 308 for collateralization of the medical claims, preparation of dashboard(s), and/or resource exchange between the medical facility and the clients (cumulatively referring to the primary clients 116 and/or the secondary client 118).

FIG. 4 presents a block diagram of the user device 400, in accordance with an exemplary embodiment. The user device 400 may represent any of the end user device 102, the primary client device 104, and the secondary client device 106, in accordance with an exemplary aspect of the present disclosure. According to the exemplary embodiment as presented through FIG. 4, the user device 400 may include a user interface 402, an application console 404, a device processor 406, a device memory 408, a communication interface 410, access point(s) 412, and a communication interface 414, communicatively coupled to each other.

The user interface 402 may include an input interface 416 for receiving input(s) from the user. Examples of the input interface 416 may include, but are not limited to, a touch interface, a mouse, a keyboard, a motion recognition unit, a gesture recognition unit, a voice recognition unit, or the like. Aspects of the present disclosure are intended to include or otherwise cover any type of the input interface 416 including known, related art, and/or later developed technologies without deviating from the scope of the present disclosure. The user interface 402 may further include an output interface 418 for rendering output(s) to the user. Examples of the output interface 418 may include, but are not limited to, a digital display, an analog display, a touch screen display, a graphical user interface, a website, a webpage, a keyboard, a mouse, a light pen, an appearance of a desktop, and/or illuminated characters. Aspects of the present disclosure are intended to include or otherwise cover any type of the output interface 418 including known, related art, and/or later developed technologies without deviating from the scope of the present disclosure.

The application console 404 may be configured as a computer-executable application, to be executed by the user device 400. The application console 404 may include suitable logic, instructions, and/or codes for executing multiple operations of the system 100 and may be controlled (or hosted) by the data processing server 108. The computer executable application(s) may be stored in the device memory 408. In some aspects of the present disclosure, the application console 404 may include an application logic 420, that may include logic, codes, and/or circuitry to control the display through the output interface 418. More particularly, the application logic may be shared with the device processor 406 that controls output(s) rendered through the output interface 418.

The device processor 406 may include suitable logic, instructions, circuitry, interfaces, and/or codes for executing various operations associated with the user device 400. In some aspects of the present disclosure, the device processor 406 may utilize processor(s) such as Arduino or raspberry pi and/or the like. Further, the device processor 406 may be configured to control operation(s) executed by the user device 400 in response to the input received at the user interface 402 from the user. Examples of the device processor 406 may include, but are not limited to, an application-specific integrated circuit (ASIC) processor, a reduced instruction set computing (RISC) processor, a complex instruction set computing (CISC) processor, a field-programmable gate array (FPGA), a Programmable Logic Control unit (PLC), and the like. Aspects of the present disclosure are intended to include or otherwise cover any type of the device processor 406 including known, related art, and/or later developed processing units, without deviating from the scope of the present disclosure.

The device memory 408 may be configured to store logic, instructions, circuitry, interfaces, and/or codes of the device processor 406, data associated with the communication controller 410, data associated with the user device 400, and data associated with the system 100. Examples of the device memory 408 may include, but are not limited to, a Read-Only Memory (ROM), a Random-Access Memory (RAM), a flash memory, a removable storage drive, a hard disk drive (HDD), a solid-state memory, a magnetic storage drive, a Programmable Read Only Memory (PROM), an Erasable PROM (EPROM), and/or an Electrically EPROM (EEPROM). Aspects of the present disclosure are intended to include or otherwise cover any type of the device memory 408 including known, related art, and/or later developed memories, without deviating from the scope of the present disclosure. In some aspects of the present disclosure, the device memory 408 may store application objects 422 specific to the computer-executable application running through the application console 404. The device memory 408 may further store instruction objects for operations of various components of the user device 400.

Communication controller 410 may include processing circuitry to enable and/or control the access point(s) 410. The access point(s) 410 generate wireless communication signals that facilitate the communication interface 414 to communicatively couple with network 112.

The communication interface 414 may be configured to enable the user device 400 to communicate with various components of the system 100 over the network 112. Examples of the communication interface 414 may include, but are not limited to, a modem, a network interface such as an Ethernet card, a communication port, and/or a Personal Computer Memory Card International Association (PCMCIA) slot and card, an antenna, a radio frequency (RF) transceiver, amplifier(s), a tuner, oscillator(s), a digital signal processor, a coder-decoder (CODEC) chipset, a Subscriber Identity Module (SIM) card, and a local buffer circuit. It will be apparent to a person of ordinary skill in the art that the communication interface 414 may include any device and/or apparatus capable of providing wireless or wired communication between the user device 400 and the other components of the system 100.

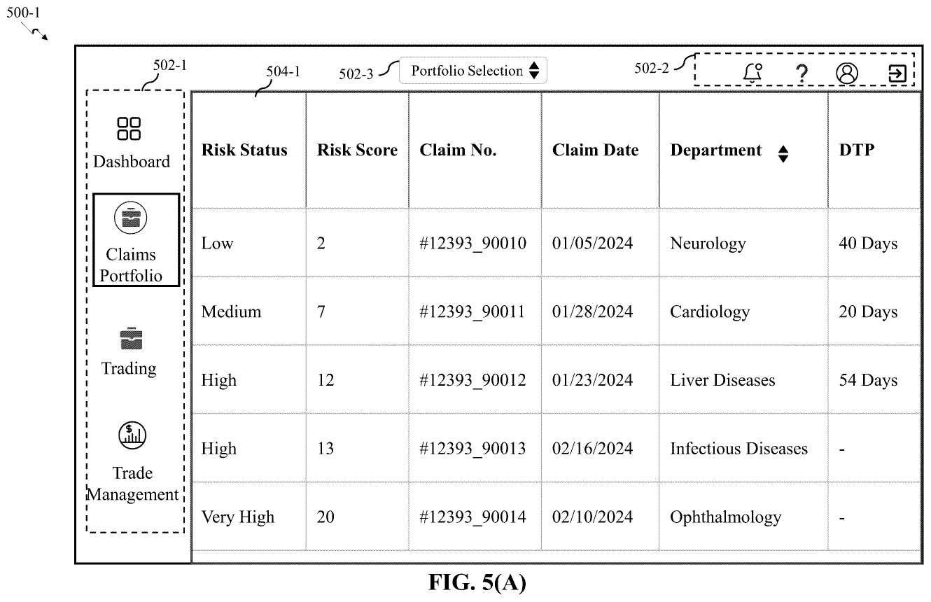

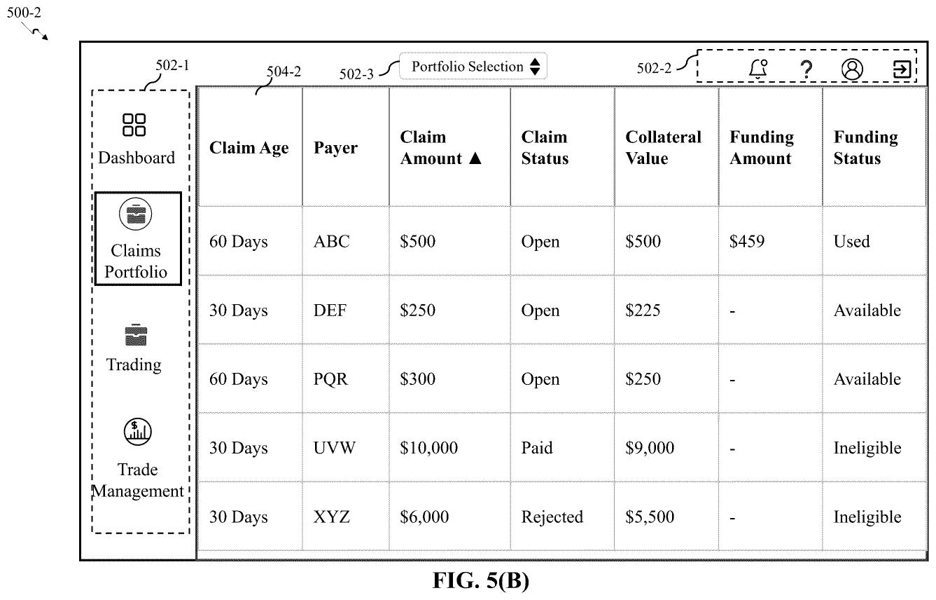

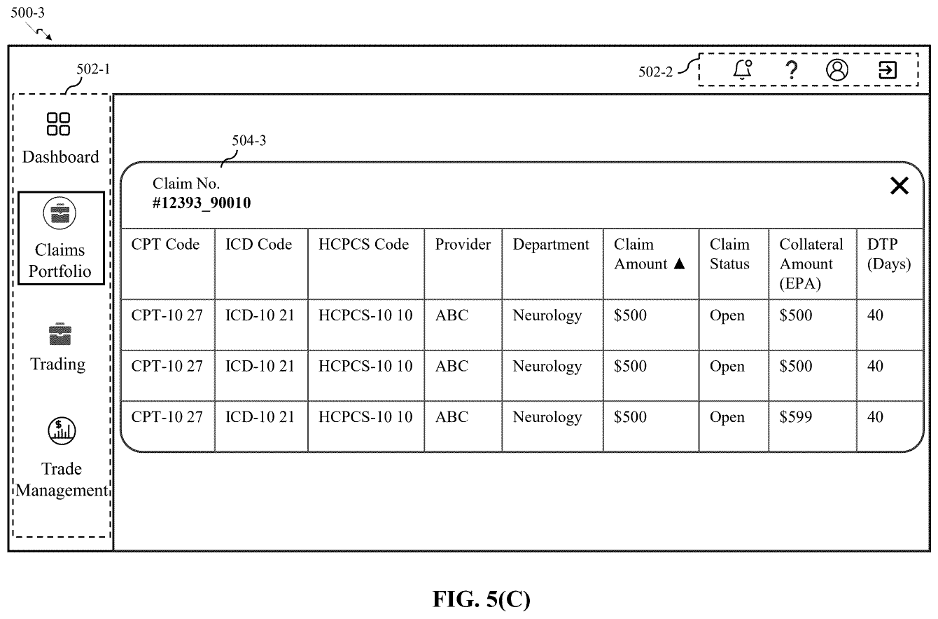

FIGS. 5(A)-5(C) illustrate Graphical User interfaces (GUIs) 500-1 through 500-3 generated by the system 100 and presented through the user device 400 corresponding to generation of claim portfolio corresponding to selected medical claims, in accordance with an exemplary aspect of the present disclosure.

More particularly, FIG. 5(A) and FIG. 5(B) illustrate example embodiments of application interfaces (i.e., the GUI 500-1 and GUI 500-2) generated by the system 100. The Application interfaces display dashboards presented through the output interface 418 of the end user device 102 to the end user 114 of the medical facility, in accordance with option(s) selected by the end user 114. The application is operated through the application console 404, controlled by the data processing server 108, and is displayed through the output interface 418. The GUI 500-1 may include elements 502-1, 502-2, 502-3, and 504-1.

The element 502-1 may include selectable option(s) to facilitate the user for selecting an operation to be performed by the system 100. Preferably, the element 502-1 may include a dashboard selection option, a claims portfolio selection option, a trading selection option, and a trade management selection option.

The element 502-2 may include selectable options for the user. Preferably, the element 502-2 may include a notification option that enables the user to view notification(s) for the user generated by the system 100. The element 502-2 may further include a help option that enables the user to input a query for operations of the application interface. Furthermore, the element 502-2 includes a user account option that enables the user to view and/or update user-account information provided by the user while registering with the system 100. Moreover, the element 502-2 includes a logout option that enables the user to log-out the user-account from the application. Logging-out may enable the user to log-in to the system using log-in details corresponding to another user-account registered with the system 100.

In the presented aspect of the present disclosure, when the claim portfolio option is selected by the user using the element 502-1, the element 502-3 is presented on the application interface. The element 502-3 may include selectable option(s) to facilitate the user to select option(s) to be displayed through the output interface 418 via the element 504-1. In some aspects of the present disclosure, the options of element 502-3 may include the claim identifier (presented as claim no.) of a medical claim, the set of input parameters of the medical claim, the set of output parameters of the medical claim, and the set of derived output parameters of the medical claim. Based on the user selection through the element 502-3, the system 100 generates display fields for the element 504-1.

In the presented aspect, the element 504-1 is presented to display the risk status, the risk score, the claim identifier (i.e., presented as the claim no.), the claim date, the department, and the DTP value. Moreover, the element 504-2 is presented to display the claim age, the primary client (i.e., presented as payer), the claim amount, status of the claim, the collateral value, a funding amount, and a funding status. It will be apparent to a person skilled in the art that the fields presented through the elements 504-1 and 504-2 are for illustration only, and the scope of the present disclosure is not limited to the. Rather, the elements 504-1 and/or 504-2 may include data fields corresponding to the claim identifier of a medical claim, the set of input parameters of the medical claim, the set of output parameters of the medical claim, and the set of derived output parameters of the medical claim, based on the user selection.

In some aspects of the present disclosure, the system 100 further facilitates the user to view medical descriptive details of various services rendered by the medical facility, presented through a medical claim. The application interface enables the user to click on a medical claim to present the medical descriptive details of the services. FIG. 5(C) presents an application interface (i.e., presented through the GUI 500-3) generated by the system 100, in response to selection of a medical claim for medical descriptive information by the user. The GUI 500-3 includes an element 504-3 that includes medical descriptive details of various services rendered by the medical facility presented in the selected claim. In the presented embodiment, the element 504-3 may include a Current Procedural Terminology (CPT), Healthcare Common Procedure Coding Systems (HCPCS) number, details of healthcare provider, department details, claim amount, claim status, collateral amount, and DTP details, for each service of the medical claim. It will be apparent to a person of ordinary skill in the art that the fields for medical descriptive information of the medical claim are for illustration only, and the scope of the present disclosure is not limited to it. Rather, the element 504-3 may include any type of medical descriptive information of services as may be derived from the medical claim generated by the healthcare facility, without deviating from the scope of the present disclosure.

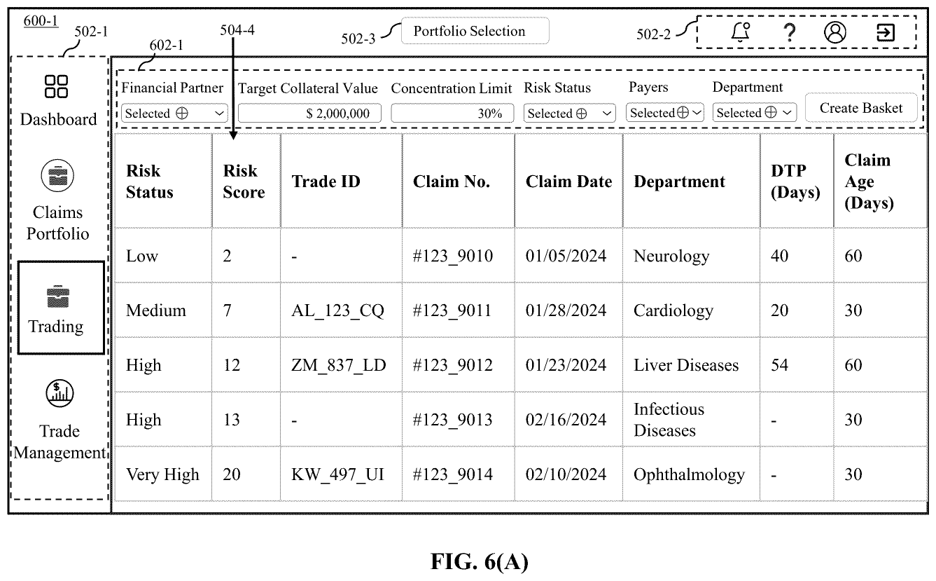

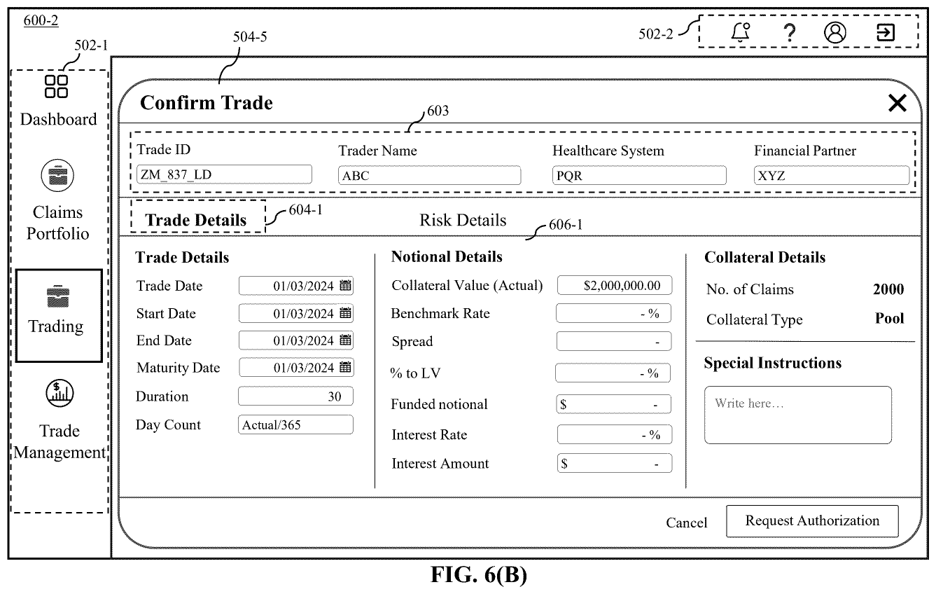

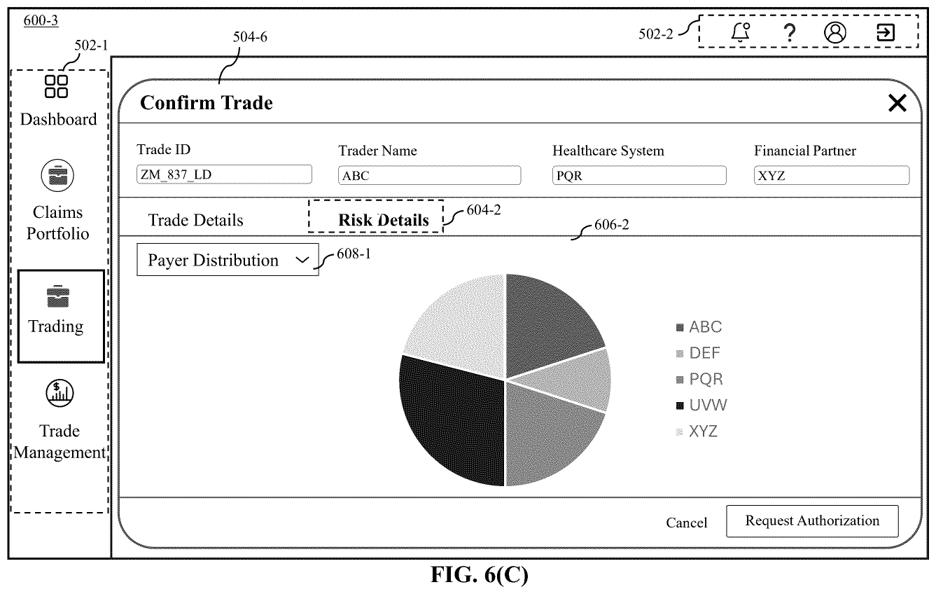

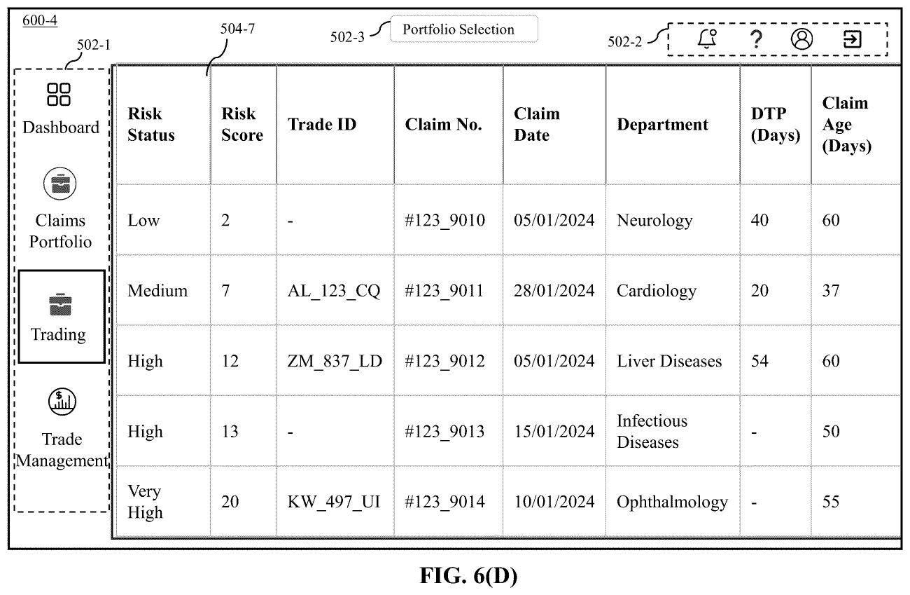

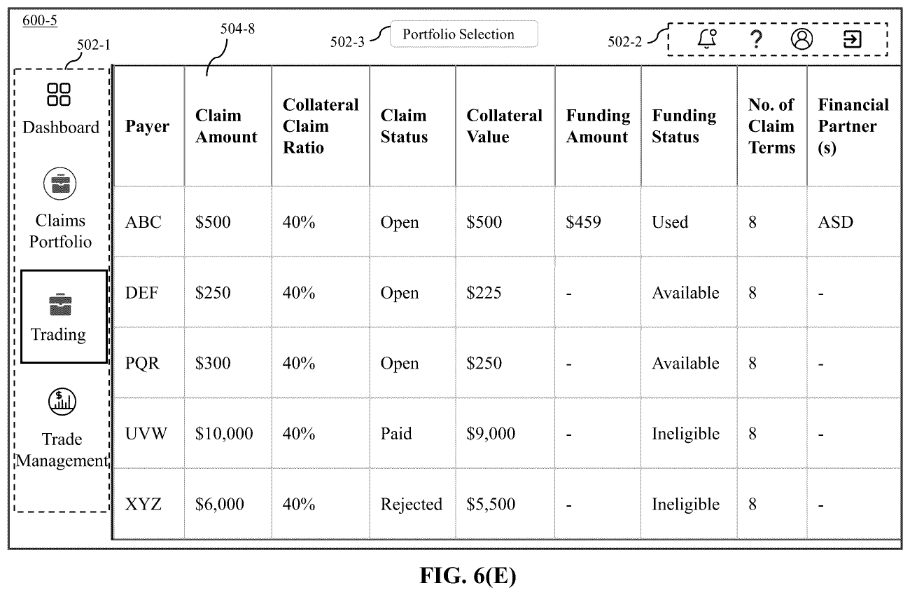

FIGS. 6(A)-6(E) illustrate application interfaces (presented through GUIs 600-1 through 600-5) generated by the system 100 and presented through the user device 400 corresponding to resource exchange, in accordance with an exemplary aspect of the present disclosure.

Particularly, FIG. 6(A) illustrates example embodiment of an application interface (i.e., the GUI 600-1) generated by the system 100. The GUI 600-1 is generated by the system 100 in response to a selection of the trading option from the element 502-1 by the user. The GUI 600-1 may include elements 502-1, 502-2, and 502-3. The GUI 600-1 may further include elements 602-1 and 504-4.

The element 602-2 may include selectable option(s) to facilitate the user to provide input(s) for resource exchange. Specifically, the element 602-1 may include an option to select the secondary client 118 (i.e., presented as financial partner), an option to select the target collateral value, an option to select the concentration limit, an option to select the risk status of medical claim(s), an option to select the primary client(s) (presented as payers), and an option to select the department. In accordance with the selection(s) of the user, the element 504-4 is generated by the system 100 and presented through the GUI 600-1 of the application interface. In the presented embodiment, the element 504-4 is presented to include the risk status, the risk score, a trade identifier (trade ID), the claim identifier (Claim ID), the claim date, the department details, and the DTP value of the medical claims determined by the system 100 based on the selection(s) by the user. It will be apparent to a person skilled in the art that the data fields included in the element 504-4 are based on the selection of the data fields by the user through the element 502-3 as presented above, and thus the scope of the present disclosure is not limited to it. Rather, the element 504-4 may include any data fields that may correspond to resource exchange between the medical facility and the secondary client 118, without deviating from the scope of the present disclosure.

The element 602-1 may further include an option to create basket of the medical claims as determined by the system based on the selections by the user from the various options of the element 602-1 and presented through the element 504-4. In an exemplary scenario, when the option to create basket is selected by the user, the application renders another application interface presented through GUI 600-2.

FIG. 6(B) and FIG. 6(C) illustrate example embodiments of application interfaces (i.e., the GUI 600-2 and GUI 600-3) generated by the system 100. The GUI 600-2 includes an element 504-5 that includes sub-element 603 and sub-element 604-1. The sub-element 603 enables the user to select options for selecting entities participating in the resource exchange. The sub-element 604-1 enables the user to select trade-details input as an option. In an exemplary scenario, when the user selects (or clicks on) the sub-element 604-1, a new sub-element 606-1 is generated by the system that is presented by the GUI 600-2. The sub-element 606-1 enables the user to select (or provide) input(s) for resource exchange. Moreover, when the user selects (or provides) inputs for resource exchange to the options of the sub-element 606-1, application renders another application interface presented through GUI 600-3.

The GUI 600-3 includes an element 504-6 that further includes a sub-element 604-2. In some aspects of the present disclosure, the sub-element 604-2 enables the user to view the risk details corresponding to the resource exchange. In an exemplary scenario, when the user selects (or clicks on) the sub-element 604-2, a new sub-element 606-2 is presented on the application interface. The sub-element 602-2 may include selectable option 608-1 that enables selection of risk parameter(s) associated with the resource exchange. Moreover, the sub-element 606-2 may also present the data of the selection through the selectable option 608-1 using various graphical options such as but not limited to graphs, bar graph, pie chart, etc. the element 504-5 and 504-6 further includes an option for request authorization of the resource exchange, that enables the user to generate a request for resource exchange based on the selected (or provided) input(s). In an exemplary scenario, when the user selects the option for request authorization, the application renders to GUI 600-4.

FIG. 6(D) and FIG. 6(E) illustrate example embodiments of application interfaces (i.e., the GUI 600-4 and GUI 600-5) generated by the system 100. The GUI 600-4 includes an element 504-7 that presents resource exchange details based on a selection of option(s) from the element 502-3 by the user. Similarly, the GUI 600-5 includes an element 504-8 that presents resource exchange details based on another selection of option(s) from the element 502-3 by the user. It will be apparent to a person of ordinary skill in the art that the data fields presented through the elements 504-7 and 504-8 are for illustration only, and the scope of the present disclosure is not limited to it. Rather, the elements 504-7 and 504-8 may include any data field related to the resource exchange, as may be selected by the user using the element 502-3.

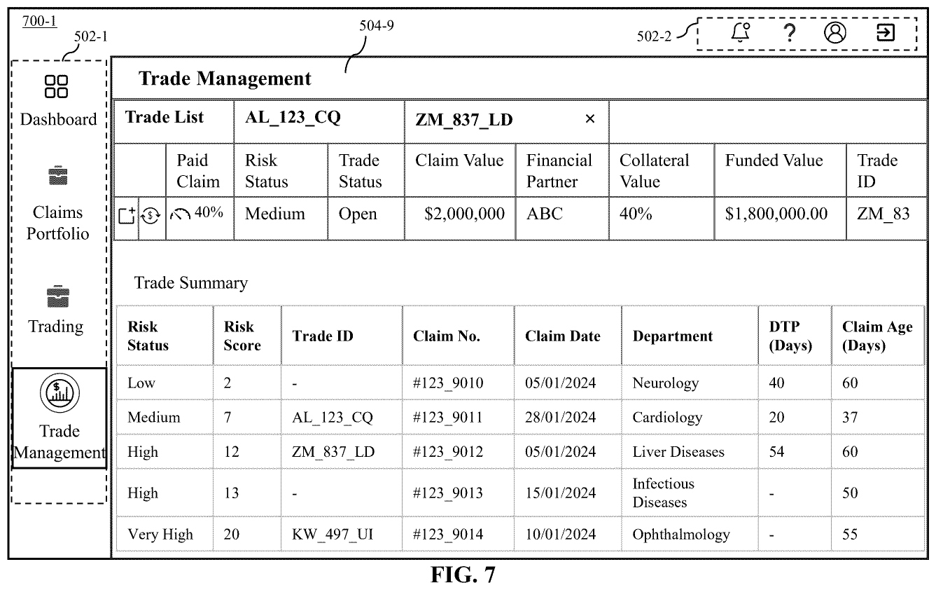

FIG. 7 illustrates an application interface (i.e., presented through GUI 700) generated by the system 100. The GUI 700 is presented on the application interface by a selection of the trade management option from the element 502-1. The GUI 700 may include an element 504-9 that presents information related to various resource exchanges of a secondary client 118. In the exemplary embodiment presented through FIG. 7, the element 504 includes a list of resource exchanges (presented as trade list) comprising selectable options for each resource exchange associated with the secondary client 118. Upon selection of a resource exchange option by the user, the application interface provides details of the selected resource exchange. The element 504-9 may further include a summary of the selected resource exchange (presented as trade summary) that may include details of the medical claim(s) corresponding to the selected resource exchange. In an exemplary scenario, when the difference between the net collateral value and the first monitory value for the first set of medical claims for a resource exchange is less than the margin exposure value, the system 100 may generate a notification for the user, that may be presented to the user by selecting the notification option in the element 502-2. Moreover, the second monitory value, the second set of medical claims and their associated details may be rendered to the user through the element 504-9 of the GUI 700.

FIG. 8(A)-8(I) illustrate GUIs 800-1 through 800-9 generated by the system 100 and presented through the user device 400 corresponding to onboarding and managing accounts of different entities (i.e., the medical facility, the primary clients 116, and the secondary clients 118) of the system 100, in accordance with an exemplary aspect of the present disclosure. The GUI 800-1 is rendered by the application interface when the user selects the dashboard option from the element 502-1. In such a scenario, the element 502-2 may indicate a settings option 802-1. In an exemplary scenario, when the user selects (or clicks on) the settings option 802-1 from the element 502-2, the system 100 may generate an element 504-10 on the GUI 800-1. The element 504-10 includes options to select and add details corresponding to various entities of the system 100 (e.g., the medical facility, the primary clients 116, and the secondary clients 118). Based on the selection(s) of the entity from the options in the element 504-10, the application renders to another application interface.

Specifically, when the user selects to add details of the medical facility, the application renders to the application interface presented through the GUI 800-2. The GUI 800-2 includes an element 504-11 comprising several selectable options (e.g., data fields) that enables the user to provide details of the medical facility to the system 100. The element 504-11 further includes an option to add a medical facility that may be submitted upon submitting input(s) for required data fields of the element 504-11. When the user provides the input(s) for the required data fields of the element 504-11 and submits the addition of the medical facility, the application may render to another application interface presented through GUI 800-3. The GUI 800-3 includes an element 504-12 that renders details of the medical facility added to the system 100. The element 504-12 further includes an option to search medical facilities added to the system 100. Furthermore, the element 504-12 may also include an option to add details of a new medical facility to the system 100, which when clicked by the user renders the application to the application interface presented through GUI 800-2.

In an exemplary scenario, when the user selects to add details of a secondary client 118 (presented as financial partner) to the system, the application renders to GUI 800-4. The GUI 800-4 may include an element 504-14 that includes a number of selectable options to enable the user for providing details of the secondary client 118 to be added to the system 100. The element 504-14 further includes an option to add a secondary client 118 to the system that may be submitted upon submitting input(s) for required data fields of the element 504-14. When the user provides the input(s) for the required data fields of the element 504-14 and submits the addition of the new secondary client 118, the application may render to another application interface presented through GUI 800-5. The GUI 800-5 includes an element 504-15 that renders details of the new secondary client added to the system 100. The element 504-15 further includes an option to search secondary client 118 added to the system 100. Furthermore, the element 504-15 may also include an option to add details of a new secondary client 118 to the system 100, which when clicked by the user renders the application to the application interface presented through GUI 800-4.

In an exemplary scenario, when the user selects to add details of a primary client 116 (presented as financial partner) to the system 100, the application renders to GUI 800-6. The GUI 800-6 may include an element 504-16 that includes a number of selectable options to enable the user for providing details of the primary client 116 to be added to the system 100. The element 504-16 further includes an option to add the primary client 116 to the system that may be submitted upon submitting input(s) for required data fields of the element 504-16. Once the details of the newly added primary client 116 are submitted, the system 100 may generate an account for the newly added primary client 116 to access the service(s) of the system 100.

In an exemplary scenario, when the user selects to add details of an end user 114 (presented as financial partner) to the system 100, the application renders to GUI 800-7. The GUI 800-7 may include an element 504-17 that includes a number of selectable options to enable the user for providing details of the end user 114 to be added to the system 100. The element 504-17 further includes an option to add the end user 114 to the system that may be submitted upon submitting input(s) for required data fields of the element 504-17. Once the details of the newly added end user 114 are submitted, the system 100 may generate an account for the newly added end user 114 to access the service(s) of the system 100.

In an exemplary scenario, when the user selects to add department details of medical facility associated with a medical claim and/or details of the preferred primary client 116 for the medical claim, the application renders to GUI 800-8. The GUI 800-8 may include an element 504-18 that includes a number of selectable options to enable the user for providing details of the department for the medical claim and select a preferred primary client 116. The element 504-18 further includes an option to add the department to the system that may be submitted upon submitting input(s) for required data fields of the element 504-18.

In an exemplary scenario, when the user selects to edit details medical facility to the system 100, the application renders to GUI 800-9. The GUI 800-9 may include an element 504-19 that includes a number of selectable options to enable the user for editing (or updating) details of the selected medical facility. The element 504-19 further includes an option to update the details of the medical facility into the server memory 122.

As will be apparent to a person of ordinary skill in the art, the GUIs presented by FIG. 5(A) through FIG. 8(I) are for illustration of some of the functions performed by the system 100, according to some exemplary aspects of the present disclosure. It must be noted that the GUIs (as presented) does not signify a specific form of data presentation or providing information to or by the system 100 that may limit the scope of the present disclosure. Rather, the system 100 may generate any type of GUIs as may be suitable to render the various operations of the system 100 presented above.

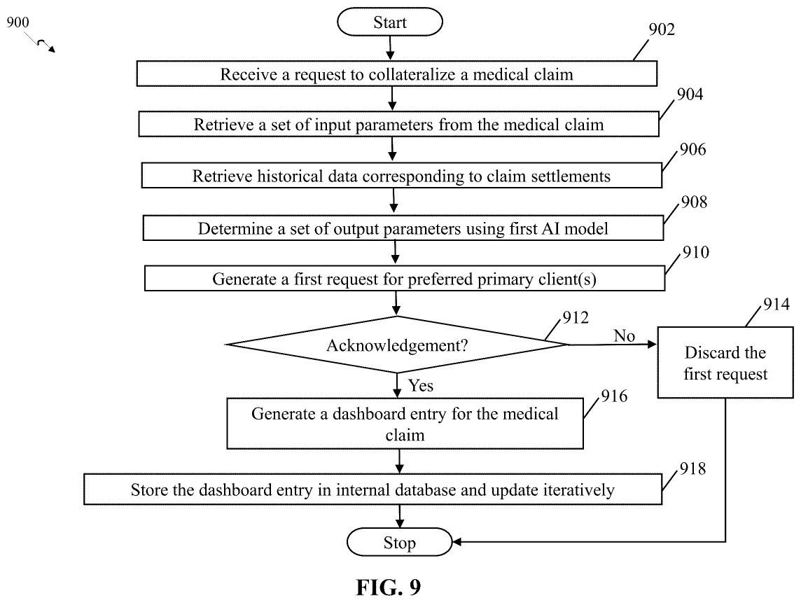

FIG. 9 is a flow chart that depicts a process 900 for generating and storing a dashboard entry corresponding to a collateralized medical claim, in accordance with an exemplary aspect of the present disclosure.

At block 902, the data processing server 108 may receive the request to collateralize a medical claim corresponding to medical service(s) rendered by the medical facility, from the end user device 102. The request to collateralize the medical claim may include details of the medical claim and details of the preferred primary client(s) 116 to collateralize the medical claim.

At block 904, the data processing server 108 may retrieve the set of input parameters for the medical claim from the request to collateralize the medical claim. The set of input parameters includes the claim identifier, the claim amount, the claim date, and details of the preferred primary client(s) 116, for the medical claim.

At block 906, the data processing server 108 may retrieve the historical claim data corresponding to past claim settlements from the server memory 122.

At block 908, the data processing server 108 may determine, through the first Machine Learning (ML) model 110 using the set of input parameters and the historical claim data, the set of output parameters for the medical claim. The set of output parameters includes the risk score for the medical claim, the expected claim settlement date, and the collateral value for the medical claim. In some aspects of the present disclosure, the data processing server 108 may further be configured to determine the set of derived output parameters using the set of output parameters. Specifically, the data processing server 108 may determine the claim age value and the DTP value for the medical claim. The claim age value corresponds to the duration between the present temporal value and the claim date. The DTP value corresponds to the duration between the present temporal value and the expected claim settlement date. In some aspects of the present disclosure, the data processing server 108 may further dynamically change the risk score in accordance with variation in the claim age value and the days to pay value for the medical claim. Particularly, the risk score and the collateral value for each medical claim dynamically change based on variation(s) in the claim age value of the medical claim, the days to pay (DTP) value for the medical claim, and/or a new claim settlement entry in the historical claim data for training the first ML model 110. Therefore, the dashboard entries may change periodically, continuously, dynamically, or based on a user's intervention, as may be determined through the first ML model 110. Moreover, the data processing server 108 may determine, for the medical claim, a risk category from a plurality of risk categories based on the risk score associated with the medical claim. Furthermore, the data processing server 108 may update the set of output parameters by associating the determined risk category to the medical claim.

At block 910, the data processing server 108 may generate the first request for the preferred primary client(s) 116 using the set of input parameters and the set of output parameters. The data processing server 108 may further transmit the first request to the preferred primary client device(s) 104 corresponding to the preferred primary client(s) 116.

At block 912, the data processing server 108 may determine, whether the first acknowledgement is received from one preferred primary client device(s) 104 in response to the first request. When the first acknowledgement is received by the data processing server 108, the process 900 proceeds to block 916. Else when the first acknowledgement is not received by the data processing server 108, the process 900 proceeds to block 914.

At block 914, the data processing server 108 may discard the first request.

At block 916, the data processing server 108 may generate a dashboard entry for the medical claim using the set of input parameters and the set of output parameters.

At block 918, the data processing server 108 may add the dashboard entry to the server memory 122. The entry may be iteratively updated by the data processing server 122 based on the changes to the set of output parameters and the set of derived output parameters due to lapse of time. In some aspects of the present disclosure, prior to the addition of the dashboard entry in the server memory 112, the data processing server 108 may further associate the medical facility identifier and the preferred primary client identifier with the dashboard entry.

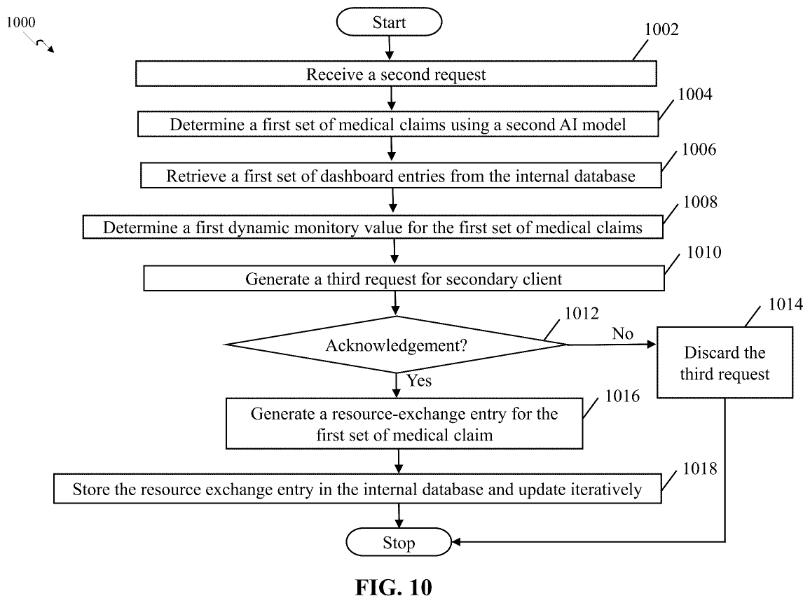

FIG. 10 is a flow chart that depicts a process 1000 for exchanging resources between the medical facility and the clients in exchange of the collateralized claims, in accordance with an exemplary aspect of the present disclosure.

At block 1002, the data processing server 108 may receive the second request from the end user device 102 associated with the medical facility. The second request includes the net collateral value, details of the secondary client 116, and the concentration limit for each preferred primary client 116.

At block 1004, the data processing server 108 may determine, through the second ML model 110, the first set of medical claims from of medical claims stored in the server memory 122, based on the second request.

At block 1006, the data processing server 108 may retrieve the first set of dashboard entries corresponding to the first set of medical claims from the server memory 122.

At block 1008, the data processing server 108 may determine, through the second ML model 110, the first monitory value corresponding to the first set of medical claims, using the first set of dashboard entries.

At block 1010, the data processing server 108 may generate the third request for the secondary client 118 using the first set of dashboard entries and the first monitory value. The data processing server 108 may further transmit the third request to the secondary client device 106 associated with the secondary client 118.

At block 1012, the data processing server 108 may determine whether the third acknowledgement is received from the secondary client device 106 in response to the third request. When the third acknowledgement is received by the data processing server 108, the process 1000 proceeds to block 1016. Else when the third acknowledgement is not received by the data processing server 108, the process 1000 proceeds to block 1014.

At block 1014, the data processing server 108 may discard the third request.

At block 1016, the data processing server 108 may generate the resource exchange entry in response to the reception of the third acknowledgement.

At block 1018, the data processing server 108 may store the resource exchange entry into the server memory 122. Moreover, the data processing server 108 may update the resource exchange entry iteratively with lapse of time. In some aspects of the present disclosure, prior to the storage of the resource exchange entry in the server memory 122, the data processing server 108 may associate the medical facility identifier and the secondary client identifier with the resource exchange entry.

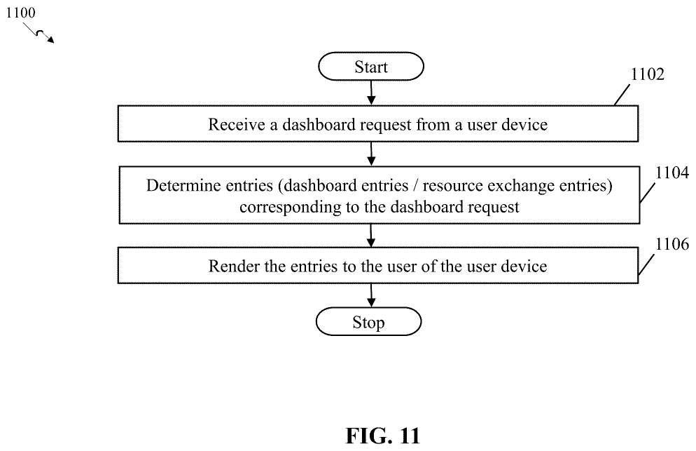

FIG. 11 is a flow chart that depicts a process 1100 for presenting information to a user of the user device 400, in accordance with an exemplary aspect of the present disclosure. The user may be an end user 114 associated with the end user device 102 corresponding to the medical facility. The user may also be the primary client 116 associated with the primary client device 104. Moreover, the user may be the secondary client 118 associated with the secondary client device 106. The information rendered to the user may correspond to transactions associated with the user.

At block 1102, the data processing server 108 may receive the dashboard request from the user device 400. The dashboard request may be associated with at least one of, the medical facility associated with the end user device 102, the secondary client 104, or the preferred primary client 106. The dashboard request may include user defined input corresponding to at least of the medical facility identifier, the secondary client identifier, or the preferred primary client identifier.

At block 1104, the data processing server 108 may determine, using the third ML model 110, entries stored in the server memory 110 based on the dashboard request. The entries may include at least one of, dashboard entries, resource exchange entries, or a combination thereof, corresponding to the user defined input.

At block 1106, the data processing server 108 may render the entries on the user device 400.

Now, referring to the technical abilities and advantageous effect of the present disclosure, the disclosure presents a platform that allows access to alternate financing by leveraging medical claims (i.e., receivables) as collateral. Given the challenges (quality, time delays upwards of 45 days, risk of payment, etc.) with medical claims processing, the platform takes a unique approach to validating the claims, identifying the risk associated with the claims & providing insights for both medical facilities and the clients to make educated decision on using the medical claim as collateral. Moreover, the platform is backed by an “Asset backed commercial paper” program from the clients that allows for them to provide funding to the customers for their operational needs, without having the customer go through regular channels (e.g., line of credit, revolver credit etc.) from their banking partners. In addition, the platform also assures medical facilities to keep track of their receivables and solve their monitory problems.

Those skilled in the art will appreciate that the methodology described herein in the present disclosure may be carried out in other specific ways than those set forth herein in the above disclosed embodiments without departing from essential characteristics and features of the present invention. The above-described embodiments are therefore to be construed in all aspects as illustrative and not restrictive.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Any combination of the above features and functionalities may be used in accordance with one or more embodiments.

In the present disclosure, each of the embodiments has been described with reference to numerous specific details which may vary from embodiment to embodiment. The foregoing description of the specific embodiments disclosed herein may reveal the general nature of the embodiments herein that others may, by applying current knowledge, readily modify and/or adapt for various applications such specific embodiments without departing from the generic concept, and, therefore, such adaptations and modifications are intended to be comprehended within the meaning of the disclosed embodiments. It is to be understood that the phraseology or terminology employed herein is for the purpose of description and is not limited in scope.

1. A method for collateralizing a plurality of medical claims, the method comprising:
receiving, from a medical facility, a request to collateralize a medical claim corresponding to at least one medical service rendered by the medical facility, wherein the request to collateralize the medical claim comprises details of the medical claim and details of at least one preferred primary client to collateralize the medical claim;
retrieving, from the request to collateralize the medical claim, a set of input parameters for the medical claim, wherein the set of input parameters comprises a claim identifier, a claim amount, a claim date, and details of the at least one preferred primary client, for the medical claim;
determining, based on the set of input parameters through a first Machine Learning (ML) model, a claim age value and a days to pay (DTP) value, for the medical claim;
retrieving, from a database, historical claim data corresponding to a plurality of historical medical claim settlements;
determining, based on the claim age value, the DTP value, and the historical claim data through the first Machine Learning (ML) model using the set of input parameters and the historical claim data, a set of output parameters for the medical claim, wherein the set of output parameters comprises comprising a risk score for the medical claim, an expected claim settlement date, and a collateral value for the medical claim, and
wherein, in response to a determination that the historical claim data comprises a new claim settlement entry, the first ML model utilizes the new claim settlement entry in the historical claim data to determine the risk score and the collateral value for each medical claim dynamically change based on at least one of a variation in the claim age value of the medical claim, a days to pay (DTP) value for the medical claim, and a new claim settlement entry in the historical claim data for training the first ML model;
generating a first request for the at least one preferred primary client using the set of input parameters and the set of output parameters;
determining, whether a first acknowledgement is received from the at least one preferred primary client in response to the first request;
generating, in response to the reception of the first acknowledgement, a dashboard entry for the medical claim using the set of input parameters and the set of output parameters; and
adding the dashboard entry to the database.

2. The method of claim 1 further comprises associating, prior to the addition of the dashboard entry in the database, a medical facility identifier and at least one preferred primary client identifier with the dashboard entry.

3. The method of claim 1, wherein the claim age value corresponds to a duration between a present temporal value and the claim date, and the DTP value corresponds to a duration between the present temporal value and the expected claim settlement date.

4. The method of claim 1, further comprising:
determining, for the medical claim, a risk category from a plurality of risk categories based on the risk score associated with the medical claim; and
updating the set of output parameters by associating the determined risk category to the medical claim.

5. The method of claim 1, further comprising:
receiving a second request from the medical facility, wherein the second request comprises a net collateral value, details of a secondary client, and a concentration limit corresponding to a maximum percentage of the net collateral value associated with each of the at least one preferred primary client;
determining, through a second ML model, a first set of medical claims from the plurality of medical claims based on the second request;
retrieving, from the database, a first set of dashboard entries corresponding to the first set of medical claims;
determining, through the second ML model, a first monitory monetary value corresponding to the first set of medical claims, using the first set of dashboard entries;
generating a third request for the secondary client using the first set of dashboard entries and the first monitory monetary value;
determining, whether a third acknowledgement is received from the secondary client in response to the third request;
generating a resource exchange entry in response to the reception of the third acknowledgement; and
storing the resource exchange entry into the database.

6. The method of claim 5 further comprises associating, prior to the storage of the resource exchange entry in the database, the medical facility identifier and a secondary client identifier with the resource exchange entry.

7. The method of claim 5, further comprising:
receiving a dashboard request from a user device associated with at least one of, the medical facility, the secondary client, or the at least one preferred primary client, wherein the dashboard request comprises user defined input corresponding to at least of the medical facility identifier, the secondary client identifier, or the at least one preferred primary client identifier;
determining, using a third ML model, one or more entries stored in the database based on the dashboard request, wherein the one or more entries comprises at least one of, one or more dashboard entries, one or more resource exchange entries, or a combination thereof, corresponding to the user defined input; and
rendering the one or more entries on the user device.

8. The method of claim 1, wherein the new claim settlement entry in the historical claim data corresponds to a change in at least one of, a ranking of each of the at least one primary client, a rating of each of the at least one primary client, and a status of each of the at least one primary client.

9. A system to collateralize a plurality of medical claims, the system comprising:
a database; and
data processing circuitry communicatively coupled with the database, wherein the data processing circuitry is configured to:
receive, from a medical facility, a request to collateralize a medical claim corresponding to at least one medical service rendered by the medical facility, wherein the request to collateralize the medical claim comprises details of the medical claim and details of at least one preferred primary client to collateralize the medical claim;
retrieve, from the request to collateralize the medical claim, a set of input parameters for the medical claim, wherein the set of input parameters comprises a claim identifier, a claim amount, a claim date, and details of the at least one preferred primary client, for the medical claim;
determine, based on the set of input parameters through a first Machine Learning (ML) model, a claim age value and a days to pay (DTP) value, for the medical claim;
retrieve, from the database, historical claim data corresponding to a plurality of historical medical claim settlements;
determine, based on the claim age value, the DTP value, and the historical claim data through the first Machine Learning (ML) model using the set of input parameters and the historical claim data, a set of output parameters for the medical claim, wherein the set of output parameters comprises comprising a risk score for the medical claim, an expected claim settlement date, and a collateral value for the medical claim, and
wherein, in response to a determination that the historical claim data comprises a new claim settlement entry, the first ML model utilizes the new claim settlement entry in the historical claim data to determine the risk score and the collateral value for each medical claim dynamically change based on at least one of a variation in a claim age value of the medical claim, a days to pay (DTP) value for the medical claim, and a new claim settlement entry in the historical claim data for training the first ML model;
generate a first request for the at least one preferred primary client using the set of input parameters and the set of output parameters;
determine, whether a first acknowledgement is received from the at least one preferred primary client in response to the first request;
generate, in response to the reception of the first acknowledgement, a dashboard entry for the medical claim using the set of input parameters and the set of output parameters; and
add the dashboard entry to the database.

10. The system of claim 9, wherein, prior to the addition of the dashboard entry in the database, the data processing circuitry is further configured to associate a medical facility identifier and at least one preferred primary client identifier with the dashboard entry.

11. The system of claim 9, wherein the claim age value corresponds to a duration between a present temporal value and the claim date, and the DTP value corresponds to a duration between the present temporal value and the expected claim settlement date.

12. The system of claim 9, wherein the data processing circuitry is further configured to:
determine, for the medical claim, a risk category from a plurality of risk categories based on the risk score associated with the medical claim; and
update the set of output parameters by associating the determined risk category to the medical claim.

13. The system of claim 12, wherein the data processing circuitry is further configured to:
receive a second request from the medical facility, wherein the second request comprises a net collateral value, details of a secondary client, and a concentration limit corresponding to a maximum percentage of the net collateral value associated with each of the at least one preferred primary client;
determine, through a second ML model, a first set of medical claims from the plurality of medical claims based on the second request;
retrieve, from the database, a first set of dashboard entries corresponding to the first set of medical claims;
determine, through the second ML model, a first monitory monetary value corresponding to the first set of medical claims, using the first set of dashboard entries;
generate a third request for the secondary client using the first set of dashboard entries and the first monitory monetary value;
determine, whether a third acknowledgement is received from the secondary client in response to the third request; and
generate a resource exchange entry in response to the reception of the third acknowledgement; and
store the resource exchange entry into the database.

14. The system of claim 13, wherein, prior to the storage of the resource exchange entry in the database, the data processing circuitry is further configured to associate the medical facility identifier and a secondary client identifier with the resource exchange entry.

15. The system of claim 13, wherein the data processing circuitry is further configured to:
receive a dashboard request from a user device associated with at least one of, the medical facility, the secondary client, or the at least one preferred primary client, wherein the dashboard request comprises user defined input corresponding to at least of the medical facility identifier, the secondary client identifier, or the at least one preferred primary client identifier;
determine, using a third ML model, one or more entries stored in the database based on the dashboard request, wherein the one or more entries comprises at least one of, one or more dashboard entries, one or more resource exchange entries, or a combination thereof, corresponding to the user defined input; and
render the one or more entries on the user device.

16. The system of claim 9, wherein the new claim settlement entry in the historical claim data corresponds to a change in at least one of, a ranking of each of the at least one primary client, a rating of each of the at least one primary client, and a status of each of the at least one primary client.

17. A computer-program product for collateralizing a plurality of medical claims, the computer program product comprising computer-executable instructions that are stored on a non-transitory computer-readable medium and that, when executed by a data processing circuitry performs operations comprising:
receiving a second request from the medical facility, wherein the second request comprises a net collateral value, details of a secondary client, and a concentration limit corresponding to a maximum percentage of the net collateral value associated with each of the at least one preferred primary client;
retrieving, from the request to collateralize the medical claim, a set of input parameters for the medical claim, wherein the set of input parameters comprises a claim identifier, a claim amount, a claim date, and details of the at least one preferred primary client, for the medical claim;
determining, based on the set of input parameters through a first Machine Learning (ML) model, a claim age value and a days to pay (DTP) value, for the medical claim;
retrieving, from a database, historical claim data corresponding to a plurality of historical medical claim settlements;
determining, based on the claim age value, the DTP value, and the historical claim data through the first Machine Learning (ML) model using the set of input parameters and the historical claim data, a set of output parameters for the medical claim, wherein the set of output parameters comprises comprising a risk score for the medical claim, an expected claim settlement date, and a collateral value for the medical claim, and
wherein, in response to a determination that the historical claim data comprises a new claim settlement entry, first ML model utilizes the new claim settlement entry in the historical claim data to determine the risk score and the collateral value for each medical claim dynamically change based on at least one of a variation in a claim age value of the medical claim, a days to pay (DTP) value for the medical claim, and a new claim settlement entry in the historical claim data for training the first ML model;
generating a first request for the at least one preferred primary client using the set of input parameters and the set of output parameters;
determining, whether a first acknowledgement is received from the at least one preferred primary client in response to the first request;
generating, in response to the reception of the first acknowledgement, a dashboard entry for the medical claim using the set of input parameters and the set of output parameters; and
adding the dashboard entry to the database.

18. The computer-program product of claim 17, wherein the operations further comprise associating, prior to the addition of the dashboard entry in the database, a medical facility identifier and at least one preferred primary client identifier with the dashboard entry.

19. The computer-program product of claim 17, wherein the claim age value corresponds to a duration between a present temporal value and the claim date, and the DTP value corresponds to a duration between the present temporal value and the expected claim settlement date.

20. The computer-program product of claim 17, wherein the operations further comprising:
determining, for the medical claim, a risk category from a plurality of risk categories based on the risk score associated with the medical claim; and
updating the set of output parameters by associating the determined risk category to the medical claim.

21. The computer-program product of claim 20, wherein the operations further comprising:
receiving a second request from the medical facility, wherein the second request comprises a net collateral value, details of a secondary client, and a concentration limit corresponding to a maximum percentage of the net collateral value associated with each of the at least one preferred primary client;
determining, through a second ML model, a first set of medical claims from the plurality of medical claims based on the second request;
retrieving, from the database, a first set of dashboard entries corresponding to the first set of medical claims;
determining, through the second ML model, a first monitory monetary value corresponding to the first set of medical claims, using the first set of dashboard entries;
generating a third request for the secondary client using the first set of dashboard entries and the first monitory monetary value;
determining, whether a third acknowledgement is received from the secondary client in response to the third request;
generating a resource exchange entry in response to the reception of the third acknowledgement; and
storing the resource exchange entry into the database.

22. The computer-program product of claim 21, wherein the operations further comprise associating, prior to the storage of the resource exchange entry in the database, the medical facility identifier and a secondary client identifier with the resource exchange entry.

23. The computer program product of claim 21, wherein the operations further comprising:
receiving a dashboard request from a user device associated with at least one of the medical facility, the secondary client, or the at least one preferred primary client, wherein the dashboard request comprises user defined input corresponding to at least of the medical facility identifier, the secondary client identifier, or the at least one preferred primary client identifier;
determining, using a third ML model, one or more entries stored in the database based on the dashboard request, wherein the one or more entries comprises at least one of, one or more dashboard entries, one or more resource exchange entries, or a combination thereof, corresponding to the user defined input; and
rendering the one or more entries on the user device.

24. The computer program product of claim 17, wherein the new claim settlement entry in the historical claim data corresponds to a change in at least one of, a ranking of each of the at least one primary client, a rating of each of the at least one primary client, and a status of each of the at least one primary client.
